(19) United States
(12) Patent Application Publication
(10) Pub. No.: US 2024/0412902 A1
(43) Pub. Date: Dec. 12, 2024

(54) REDUCED CRITICAL CERIUM-BASED HIGH TEMPERATURE MAGNET

(71) Applicants: UT-Battelle, LLC, Oak Ridge, TN (US); Iowa State University Research Foundation, Inc., Ames, IA (US)

(72) Inventors: David S. Parker, Oak Ridge, TN (US); Li Yin, New Orleans, LA (US); Jiaqiang Yan, Knoxville, TN (US); Jun Cui, Ames, IA (US); Wei Tang, Ames, IA (US); Brian C. Sales, Lenoir City, TN (US)

(21) Appl. No.: 18/640,334

(22) Filed: Apr. 19, 2024

Related U.S. Application Data
(60) Provisional application No. 63/460,914, filed on Apr. 21, 2023.

(51) Int. Cl. H01F 1/055

(52) U.S. Cl. CPC H01F 1/055

(57) ABSTRACT

A bulk permanent magnet composition comprising the formula (Ce₁₋ₓM¹ₓ)_{2.7-(v+w)}M²ᵥ(Fe_{14-y}Co_{y})_{1-z}M³_{z}B, or alternatively, (Ce₁₋ₓM¹ₓ)₂₋ᵥM²ᵥ(Fe_{14-y}Co_{y})_{1-z}M³_{z}B, wherein: M¹ represents at least one lanthanide element other than Ce; M² represents at least one element selected from the group consisting of Sn, Sb, Bi, Pb, Ca, Sr, and Zr; M³ represents at least one element selected from the group consisting of Ti, Cr, Mn, Ni, Cu, Zn, Zr, Nb, Mo, W, Ta, and Hf; 0≤x<1; 0≤v≤1; 0≤y≤3; 0≤w≤0.8; and 0≤z≤1. Also described herein are methods for producing the permanent magnet.

### CROSS REFERENCE TO RELATED APPLICATION

The present application claims benefit of U.S. Provisional Application No. 63/460,914, filed on Apr. 21, 2023, all of the contents of which are incorporated herein by reference.

### STATEMENT REGARDING FEDERALLY SPONSORED RESEARCH

This invention was made with government support under Prime Contract No. DE-AC05-000R22725 and DE-AC02-07CH11358, both awarded by the U.S. Department of Energy. The government has certain rights in the invention.

### FIELD OF THE INVENTION

The present invention relates, generally, to rare earth-based permanent magnets, and more particularly, to such magnets containing cerium, which may be in combination with lanthanum, and more particularly, where neodymium or dysprosium is in a minor amount or excluded. The present invention also relates to methods for producing such magnets.

### BACKGROUND

To date, permanent magnets can be roughly considered to fall into three groups: the Nd₂Fe₁₄B and Sm—Co-based high performance rare-earth magnets, the relatively low performance ferrite magnet, and the alnico-represented intermediate gap magnet. A large percentage of present day rare earth magnets suffer from a high percentage, as much as 32 weight percent, of the critical rare earth elements Nd and Dy, which are very costly and in limited supply. This amounts to a significant hindrance for domestic energy-relevant applications, such as electric vehicle traction motors and direct-drive wind turbines.

Considering the low availability of critical expensive elements, such as Nd, Sm, and Dy, there has been an ongoing effort to find more abundant and lower cost high performance magnets. However, efforts in achieving permanent magnets relying on lower cost elements and which exhibit similar or same energy product (BHₘₐₓ) and high Curie points as the currently known permanent magnets in widespread use have been largely unsuccessful. Thus, the provision of such a magnet would be a significant advance in the field of permanent magnets.

### SUMMARY

The present disclosure is foremost directed to permanent (hard) cerium-based ferromagnetic alloy magnetic compositions that rely more on lower cost elements (e.g., Ce and La), and conversely, rely less on more costly elements such as Nd and Dy. In some embodiments, higher cost elements, such as Nd or Dy, are excluded. In some embodiments, the magnetic compositions have exceptional Curie points (e.g., above the 585 K Curie point of commercial Nd₂Fe₁₄B) without relying on incorporation of Dy or Nd, and in some instances, with a substantially lower amount of Co than used in SmCo₅. The permanent magnet may include at least cerium (Ce), iron (Fe), cobalt (Co), and boron (B), and optionally, one or more of lanthanum (La), bismuth (Bi), and zirconium (Zr).

More particularly, the permanent magnet has the composition (Ce₁₋ₓM¹ₓ)_{2.7-(v+w)}M²ᵥ(Fe_{14-y}Co_{y})_{1-z}M³_{z}B, denoted as Formula (1), wherein 0≤x<1; 0≤v≤1; 0≤y≤3; 0≤w≤0.8; and 0≤z≤1, wherein M¹ represents one or more lanthanide elements other than Ce; M² represents at least one element selected from the group consisting of Sn, Sb, Bi Pb, Ca, Sr, and Zr; and M³ represents at least one element selected from the group consisting of Ti, Cr, Mn, Ni, Cu, Zn, Zr, Nb, Mo, W, Ta, or Hf. In further or alternative embodiments, the permanent magnet has the composition (Ce₁₋ₓM¹ₓ)₂₋ᵥM²ᵥ(Fe_{14-y}Co_{y})_{1-z}M³_{z}B, or more particularly, (Ce₁₋ₓM¹ₓ)₂₋ᵥM²ᵥ(Fe_{14-y}Co_{y})B. In particular embodiments of any of these or other formulas disclosed in this application, any one or more of the following ranges may be selected: 0<x<1, 0.1≤x<1, 0.1≤x≤0.8, 0<y≤3, 0≤y≤2, 0<y≤2, 0.01≤v≤1, 0.1≤v≤1, 0≤v≤1, 0≤v≤0.4, 0≤v≤0.2, 0≤z≤1, 0.1≤z≤1, and 0.01≤z≤1. In some embodiments, in any of the foregoing formulas, where applicable, any one or more of the following conditions may apply: 0.01≤v≤1, 0≤v≤1, 0≤v≤0.4, 0≤v≤0.2, 0.1≤v≤1, 0≤z≤1, 0.01≤z≤1, or 0.1≤z≤1. In some embodiments, the permanent magnet excludes Nd, Dy, or both.

The magnetic composition described herein substantially reduces expensive, critical rare earth content in high performance magnets while maintaining room temperature magnetic properties. The permanent magnet may have some of the following exemplary properties: 300 K Magnetization of 1.5 Tesla or higher; Curie point of 700 K or higher; 300 K Anisotropy Field of 5.5 Tesla or higher. The energy product may be 5-55 MG-Oe, or in some cases, about 5-20 MG-Oe, with coercivities as high as 6 kOe or higher. Each of these properties is important in a permanent magnet: i.e., the magnetization sets an upper limit on BHₘₐₓ, the Curie point (or ferromagnetic ordering point) determines the usable temperature range of the magnet, and a sufficient anisotropy field (generally a minimum of three times the magnetization) permits subsequent development of sufficient coercivity to prevent demagnetization.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1. The X-ray powder diffraction of (LaCe)₂₋ₓZrₓFe_{12.7}Co_{1.3}B (x=0.0. 0.1 or 0.2) collected at room temperature. The reflection marked by * comes from free Fe.

FIGS. 2a-2b. FIG. 2a is a graph showing field dependence of the magnetization for Ce₂Fe₁₄B with La and Zr substitutions to determine the saturation magnetization at room temperature. FIG. 2b is a graph showing yield dependence of magnetization of aligned powder with magnetic field applied along the hard direction. The measurements were performed at room temperature.

FIGS. 3a-3c. FIG. 3a shows side-view geometry structures of Ce₂Fe₁₄B. The two kinds of Ce, six kinds of Fe atoms, and B atoms in Ce₂Fe₁₄B are marked with different color balls respectively. FIG. 3b is a graph showing the total density of states (DOS), f-orbital DOS of inequivalent Ce atoms and d-orbital DOS of Fe atoms in Ce₂Fe₁₄B. The Ce-4f (Ce-4g) label denotes the Ce atoms in the 4f (4g) site, as marked in FIG. 3a. The d-orbital DOS of Fe atom is averaged over the d-orbital DOS of all sites of Fe atoms. The positive and negative values in the vertical axis denote the spin-up and spin-down channels, respectively. The Fermi level is 0 eV. FIG. 3c is a chart showing the magnetic anisotropy energy (MAE) calculated with SOC employed in different atoms Ce₂Fe₁₄B.

FIGS. 4a-4d. Graphs showing the partial DOS projected on the f states of Ce-4f (FIG. 4a) and Ce-4g atoms (FIG. 4b) in Ce₂Fe₁₄B. The Fermi level is 0 eV. The inset in FIG. 4b denotes the spin-polarized partial DOS projected on the p states of B atoms. FIG. 4c and FIG. 4d show spin-up and spin-down charge densities, respectively, projected on the (001) plane in Ce₂Fe₁₄B. The spatial distance of the displayed (001) plane is 1.0c, where c is the z-directional lattice constant of Ce₂Fe₁₄B. The value of charge density is depicted as the color bar.

FIGS. 5a-5b. FIG. 5a is a graph showing the relative energy of E_{4f} with respect to the corresponding E_{4g} in (Ce_{0.75}X_{0.25})₂Fe₁₄B (X=Sn, Sb, Pb, Bi, Ca, Sr, La or Zr). FIG. 5b is a chart showing the calculated MAE in Ce₂Fe₁₄B, (Ce_{0.75}X_{0.25})₂Fe₁₄B (X=Sn, Sb, Pb, Bi, La and Zr) and (Ce_{0.5}Bi_{0.5})₂Fe₁₄B. The introduced Sn, Sb, Pb, Bi and Zr atoms in FIG. 5b occupy the 4f site, and the La atoms in FIG. 5b are located at the 4g site.

FIGS. 6a-6b FIG. 6a is a chart showing the spin (orbital) moment difference Aps (ΔP_{L}) of Fe atoms in (Ce_{0.5}Bi_{0.5})₂Fe₁₄B and Ce₂Fe₁₄B. A positive value of the moment difference means a larger moment in (Ce_{0.5}Bi_{0.5})₂Fe₁₄B, as compared with Ce₂Fe₁₄B. FIG. 6b is a graph showing the spin-polarized DOS projected on the p states in Bi-4f atom and the d states of Fe-4c atom in (Ce_{0.5}Bi_{0.5})₂Fe₁₄B. The red dashed lines correspond to the d-projected DOS of Fe-4c atom in Ce₂Fe₁₄B. The inset in FIG. 6b denotes the p-projected DOS of Bi-4f atom in (Ce_{0.5}Bi_{0.5})₂Fe₁₄B, in the energy interval of [E_{F}-4.8 eV, E_{F}-3.8 eV] as marked by the grey region. The Fermi level is 0 eV.

FIG. 7. Process flow chart of Mischmetal (MM) magnet fabrication.

FIG. 8. Sintering and annealing schedule.

FIG. 9. Room-temperature hysteresis loops for the indicated alloy with grain boundary modifiers as indicated.

### DETAILED DESCRIPTION

In one aspect, the present disclosure is directed to a bulk permanent magnet (“magnet”) having the formula (Ce₁₋ₓM¹ₓ)_{2.7-(v+w)}M²ᵥ(Fe_{14-y}Co_{y})_{1-z}M³_{z}B, which may denoted herein as Formula (1). In a particular sub-formula of Formula (1), the permanent magnet has the formula (Ce₁₋ₓM¹ₓ)₂₋ᵥM²ᵥ(Fe_{14-y}Co_{y})_{1-z}M³_{z}B, which may be denoted here as Formula (1a). In a further sub-formula of Formula (1a), the permanent magnet has the formula (Ce₁₋ₓM¹ₓ)₂₋ᵥM²ᵥ(Fe_{14-y}Co_{y})B (i.e., when z is 0), which may be denoted here as Formula (1b). Notably, all subscript values correspond to molar amounts.

The variable M¹ represents at least one lanthanide element (or at least two or more lanthanide elements) other than Ce. The term “lanthanide element” refers to any of the elements (other than Ce) having an atomic number of 57-71, e.g., lanthanum (La), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). In some embodiments, M¹ is or includes La and/or Pr. In some embodiments, one or both of Nd and Dy are excluded from M¹, or Nd and/or Dy are independently or in sum present in a trace amount, which may be a molar amount of no more than or below, for example, 0.1, 0.05, or 0.01 by total molar amount of Ce and M¹. In some embodiments, M¹ is not present (i.e., when x is 0).

The variable M² represents at least one element (or at least two or more elements) selected from Sn, Sb, Bi, Pb, Ca, Sr, and Zr. In a first embodiment, M² is or includes Sn. In a second embodiment, M² is or includes Sb. In a third embodiment, M² is or includes Bi. In a fourth embodiment, M² is or includes Pb. In a fifth embodiment, M² is or includes Ca. In a sixth embodiment, M² is or includes Sr. In a seventh embodiment, M² is or includes Zr. In other embodiments, any two or more of the above first through seventh embodiments are combined, e.g., M² may represent at least Bi and/or Zr, and may or may not include (or may exclude) one or more other elements selected from Sn, Sb, Bi Pb, Ca, Sr, and Zr. In some embodiments, any one or more of the above elements for M² is/are excluded or present independently or in sum in a trace amount. In some embodiments, M² is not present (i.e., when v is 0).

The variable M³ represents at least one element (or at least two or more elements) selected from Ti, Cr, Mn, Ni, Cu, Zn, Zr, Nb, Mo, W, Ta, and Hf. In a first embodiment, M³ is or includes Ti. In a second embodiment, M³ is or includes Cr. In a third embodiment, M³ is or includes Mn. In a fourth embodiment, M³ is or includes Ni. In a fifth embodiment, M³ is or includes Cu. In a sixth embodiment, M³ is or includes Zn. In a seventh embodiment, M³ is or includes Zr. In an eighth embodiment, M³ is or includes Nb. In a ninth embodiment, M³ is or includes Mo. In a tenth embodiment, M³ is or includes W. In an eleventh embodiment, M³ is or includes Ta. In a twelfth embodiment, M³ is or includes Hf. In other embodiments, any two or more of the above first through twelfth embodiments are combined. In some embodiments, any one or more of the above elements for M³ is/are excluded or present independently or in sum in a trace amount. In some embodiments, M³ is not present (i.e., when z is 0).

The variable x represents the stoichiometric (molar) amount of M¹, i.e., at least one lanthanide other than cerium, present in the magnetic composition. In different embodiments, x can be, for example, 0, 0.1, 0.15, 0.2, 0.25, 0.3, 0.35, 0.4, 0.45, 0.5, 0.55, 0.6, 0.65, 0.7, 0.75, 0.8, 0.85, 0.9, or 0.95, or x may have a value within a range bounded by any two of the foregoing values. Any of the foregoing values may be combined to form a range in which one of the values represents a lower bound (minimum) and the other value represents an upper bound (maximum) for x, wherein the lower or upper bound value may be included or excluded from the range. As an example, x having a lower bound of at least 0.25 and an upper bound of up to 0.75 is expressed as 0.25≤x≤0.75, while x having a lower bound of at least 0.25 and an upper bound of less than 0.75 is expressed as 0.25≤x<0.75, while x having a lower bound above 0.25 and an upper bound of up to 0.75 is expressed as 0.25<x≤0.75, while x having a lower bound above 0.25 and an upper bound of less than 0.75 is expressed as 0.25<x<0.75.

A number of exemplary ranges for x in which x has an upper bound less than 1 are provided as follows: 0≤x<1, 0≤x<1, 0.1≤x<1, 0.1≤x<1, 0.15≤x<1, 0.15≤x<1, 0.2≤x<1, 0.2≤x<1, 0.25≤x<1, 0.25≤x<1, 0.3≤x<1, 0.3≤x<1, 0.35≤x<1, 0.35≤x<1, 0.4≤x<1, 0.4≤x<1, 0.45≤x<1, 0.45≤x<1, 0.5≤x<1, 0.5≤x<1, 0.55 x<1, 0.55≤x<1, 0.6 x<1, 0.6≤x<1, 0.65 x<1, 0.65≤x<1, 0.7 x<1, 0.7<x<1, 0.75≤x<1, 0.75≤x<1, 0.8≤x<1, 0.8≤x<1, 0.85≤x<1, 0.85<x<1, 0.9≤x<1, 0.9≤x<1, 0.95≤x<1, and 0.95<x<1.

A number of exemplary ranges for x in which x has an upper bound of up to or less than 0.8 are provided as follows: 0≤x<0.8, 0≤x<0.8, 0≤x≤0.8, 0≤x≤0.8, 0.1≤x<0.8, 0.1<x≤0.8, 0.1≤x≤0.8, 0.1≤x≤0.8, 0.15≤x≤0.8, 0.15≤x≤0.8, 0.15≤x≤0.8, 0.15≤x≤0.8, 0.2≤x≤0.8, 0.2≤x≤0.8, 0.2≤x≤0.8, 0.2≤x≤0.8, 0.25≤x≤0.8, 0.25<x≤0.8, 0.25≤x≤0.8, 0.25≤x≤0.8, 0.3≤x≤0.8, 0.3≤x≤0.8, 0.3≤x≤0.8, 0.3≤x≤0.8, 0.35≤x≤0.8, 0.35<x≤0.8, 0.35≤x≤0.8, 0.35≤x≤0.8, 0.4≤x≤0.8, 0.4<x≤0.8, 0.4≤x≤0.8, 0.4≤x≤0.8, 0.45≤x≤0.8, 0.45≤x≤0.8, 0.45≤x≤0.8, 0.45≤x≤0.8, 0.5≤x≤0.8, 0.5≤x≤0.8, 0.5≤x≤0.8, 0.5<x≤0.8, 0.55≤x≤0.8, 0.55≤x≤0.8, 0.55≤x≤0.8, 0.55≤x≤0.8, 0.6≤x≤0.8, 0.6<x<0.8, 0.6≤x≤0.8, 0.6<x≤0.8, 0.65≤x≤0.8, 0.65<x<0.8, 0.65≤x≤0.8, and 0.65<x≤0.8.

A number of exemplary ranges for x in which x has an upper bound of up to or less than 0.6 are provided as follows: 0≤x<0.6, 0≤x<0.6, 0≤x≤0.6, 0<x≤0.6, 0.1≤x<0.6, 0.1<x<0.6, 0.1≤x≤0.6, 0.1≤x≤0.6, 0.15≤x≤0.6, 0.15≤x≤0.6, 0.15≤x≤0.6, 0.15≤x≤0.6, 0.2≤x≤0.6, 0.2≤x≤0.6, 0.2≤x≤0.6, 0.2≤x≤0.6, 0.25≤x≤0.6, 0.25<x<0.6, 0.25≤x≤0.6, 0.25≤x≤0.6, 0.3≤x≤0.6, 0.3≤x≤0.6, 0.3≤x≤0.6, 0.3<x≤0.6, 0.35≤x≤0.6, 0.35<x≤0.6, 0.35≤x≤0.6, 0.35≤x≤0.6, 0.4≤x≤0.6, 0.4<x<0.6, 0.4≤x≤0.6, and 0.4<x≤0.6.

A number of exemplary ranges for x in which x has an upper bound of up to or less than 0.5 are provided as follows: 0≤x<0.5, 0≤x<0.5, 0≤x≤0.5, 0<x≤0.5, 0.1 x<0.5, 0.1<x<0.5, 0.1≤x≤0.5, 0.1≤x≤0.5, 0.15≤x≤0.5, 0.15≤x≤0.5, 0.15≤x≤0.5, 0.15<x≤0.5, 0.2≤x≤0.5, 0.2≤x≤0.5, 0.2≤x≤0.5, 0.2≤x≤0.5, 0.25≤x≤0.5, 0.25<x<0.5, 0.25≤x≤0.5, 0.25≤x≤0.5, 0.3≤x≤0.5, 0.3≤x≤0.5, 0.3≤x≤0.5, 0.3<x≤0.5, 0.35≤x<0.5, 0.35<x<0.5, 0.35≤x<0.5, 0.35≤x≤0.5, 0.4≤x<0.5, 0.4<x<0.5, 0.4≤x≤0.5, and 0.4<x≤0.5.

A number of exemplary ranges for x in which x has an upper bound of up to or less than 0.3 are provided as follows: 0≤x<0.3, 0<x<0.3, 0≤x≤0.3, 0≤x≤0.3, 0.1≤x<0.3, 0.1<x≤0.3, 0.1≤x≤0.3, 0.1≤x≤0.3, 0.15≤x<0.3, 0.15<x<0.3, 0.15≤x≤0.3, and 0.15<x≤0.3.

The variable y represents the stoichiometric (molar) amount of cobalt present in the magnetic composition. In different embodiments, y can be, for example, 0, 0.1, 0.2, 0.3, 0.4, 0.5, 0.6, 0.7, 0.8, 0.9, 1, 1.2, 1.5 1.8, 2, 2.2, 2.5, 2.8, or 3, or y may have a value within a range bounded by any two of the foregoing values.

A number of exemplary ranges for y in which y has an upper bound of up to or less than 3 are provided as follows: 0≤y≤3, 0≤y≤3, 0≤y≤3, 0≤y≤3, 0.1≤y≤3, 0.1<y≤3, 0.1≤y≤3, 0.1<y<3, 0.2≤y≤3, 0.2≤y≤3, 0.2≤y≤2, 0.2≤y≤3, 0.3≤y≤3, 0.3≤y≤3, 0.3≤y≤3, 0.3≤y≤3, 0.4≤y≤3, 0.4≤y≤3, 0.4≤y≤3, 0.4≤y≤3, 0.5≤y≤3, 0.5≤y≤3, 0.5≤y≤3, 0.5≤y≤3, 0.6≤y≤3, 0.6≤y≤3, 0.6≤y≤3, 0.6≤y≤3, 0.7≤y≤3, 0.7≤y≤3, 0.7≤y≤3, 0.7≤y≤3, 0.8≤y≤3, 0.8≤y≤3, 0.8≤y≤3, 0.8≤y≤3, 0.9≤y≤3, 0.9≤y≤3, 0.9≤y≤3, 0.9≤y≤3, 1≤y≤3, 1≤y≤3, 1≤y≤3, 1≤y≤3, 1.2≤y≤3, 0.21y≤3, 0.21y≤3, 0.21y≤3, 0.5≤y≤3≤1.5≤y≤3≤1.5≤y≤3, 1.5≤y≤3, 1.8≤y≤3, 1.8≤y≤3, 1.8≤y≤3, 1.8≤y≤3, 2≤y≤3, 2≤y≤3, 2≤y≤3, 2<y<3, 2.2≤y≤3, 2.2≤y≤3, 2.2≤y≤3, 2.2≤y<3, 2.5≤y≤3, 2.5<y≤3, 2.5≤y<3, 2.5<y<3, 2.8≤y≤3, 2.8<y≤3, 2.8≤y<3, and 2.8<y<3. Moreover, any of the ranges or specific values provided above for y can be combined with any of the ranges or specific values provided earlier above for x.

A number of exemplary ranges for y in which y has an upper bound of up to or less than 2 are provided as follows: 0≤y≤2, 0≤y≤2, 0≤y≤2, 0≤y≤2, 0.1≤y≤2, 0.1<y≤2, 0.1≤y<2, 0.1<y<2, 0.2≤y≤2, 0.2≤y≤2, 0.2≤y≤2, 0.2≤y≤2, 0.3≤y≤2, 0.3≤y≤2, 0.3≤y≤2, 0.3≤y≤2, 0.4≤y≤2, 0.4≤y≤2, 0.4≤y≤2, 0.4≤y≤2, 0.5≤y≤2, 0.5≤y≤2, 0.5≤y≤2, 0.5≤y≤2, 0.6≤y≤2, 0.6≤y≤2, 0.6≤y≤2, 0.6≤y≤2, 0.7≤y≤2, 0.7≤y≤2, 0.7≤y≤2, 0.7≤y≤2, 0.8≤y≤2, 0.8≤y≤2, 0.8≤y≤2, 0.8≤y≤2, 0.9≤y≤2, 0.9<y≤2, 0.9≤y≤2, 0.9≤y≤2, 1≤y≤2, 1≤y≤2, 1≤y≤2, 1<y<2, 1.2≤y≤2, 1.2≤y≤2, 1.2≤y<2, 1.2≤y≤2, 1.5≤y≤2, 1.5≤y≤2, 1.5≤y≤2, 1.5<y<2, 1.8≤y≤2, 1.8<y≤2, 1.8≤y<2, and 1.8<y<2. Moreover, any of the ranges or specific values provided above for y can be combined with any of the ranges or specific values provided earlier above for x.

A number of exemplary ranges for y in which y has an upper bound of up to or less than 1 are provided as follows: 0≤y≤1, 0≤y≤1, 0≤y≤1, 0≤y≤1, 0.1≤y≤1, 0.1<y≤1, 0.1≤y≤1, 0.1≤y≤1, 0.2≤y≤1, 0.2≤y≤1, 0.2≤y≤1, 0.2≤y≤1, 0.3≤y≤1, 0.3≤y≤1, 0.3≤y≤1, 0.3≤y≤1, 0.4y≤1, 0.4≤y≤1, 0.4≤y≤1, 0.4≤y≤1, 0.5≤y≤1, 0.5≤y≤1, 0.5≤y≤1, 0.5≤y≤1, 0.6≤y≤1, 0.6≤y≤1, 0.6≤y≤1, 0.6≤y≤1, 0.7≤y≤1, 0.7≤y≤1, 0.7<y≤1, 0.7<y<1, 0.8≤y≤1, 0.8<y≤1, 0.8≤y<1, and 0.8<y<1. Moreover, any of the ranges or specific values provided above for y can be combined with any of the ranges or specific values provided earlier above for x.

The variable v represents the stoichiometric (molar) amount of M², i.e., at least one element selected from Sn, Sb, Bi, Pb, Ca, Sr, and Zr, present in the magnetic composition. In different embodiments, v can be, for example, 0, 0.01, 0.1, 0.2, 0.3, 0.4, 0.5, 0.6, 0.7, 0.8, 0.9, or 1, or v may have a value within a range bounded by any two of the foregoing values.

A number of exemplary ranges for v in which v has an upper bound of up to or less than 1 are provided as follows: 0≤v≤1, 0≤v≤1, 0≤v≤1, 0≤v≤1, 0.01≤v≤1, 0.01≤v≤1, 0.01≤v≤1, 0.01≤v≤1, 0.1≤v≤1, 0.1≤v≤1, 0.1≤v≤1, 0.1≤v≤1, 0.2≤v≤1, 0.2≤v≤1, 0.2≤v≤1, 0.2≤v≤1, 0.3≤v≤1, 0.3≤v≤1, 0.3≤v≤1, 0.3≤v≤1, 0.4≤v≤1, 0.4≤v≤1, 0.4≤v≤1, 0.4≤v≤1, 0.5≤v≤1, 0.5≤v≤1, 0.5≤5 v≤1, 0.5<v<1, 0≤v≤10.6≤v≤1, 0.6 v≤1, 0.6≤v≤1, 0.7≤v≤1, 0.7≤v≤1, 0.7≤v≤1, 0.7<v<1, 0.8≤v≤1, 0.8<v≤1, 0.8≤v≤1, 0.8≤v≤1, 0.9≤v≤1, 0.9≤v≤1, and 0.9≤v<1. Moreover, any of the ranges or specific values provided above for v can be combined with any of the ranges or specific values provided earlier above for x and y.

A number of exemplary ranges for v in which v has an upper bound of up to or less than 0.8 are provided as follows: 0≤v≤0.8, 0≤v≤0.8, 0≤v≤0.8, 0≤v≤0.8, 0.01≤v≤0.8, 0.01≤v≤0.8, 0.01≤y≤0.8, 0.01≤v≤0.8, 0.1≤v≤0.8, 0.1≤v≤0.8, 0.1≤0.8, 0.1<v≤0.8, 0.2≤v≤0.8, 0.2≤v≤0.8, 0.2≤v≤0.8, 0.2≤v≤0.8, 0.3≤v≤0.8, 0.3<v≤0.8, 0.3≤v≤0.8, 0.3<v≤0.8, 0.4≤v≤0.8, 0.4≤v≤0.8, 0.4≤y≤0.8, 0.4≤v≤0.8, 0.5≤v≤0.8, 0.5≤v≤0.8, 0.5 v≤0.8, 0.5≤v≤0.8, 0.6≤v≤0.8, 0.6<v≤0.8, 0.6≤v<0.8, and 0.6<v<0.8. Moreover, any of the ranges or specific values provided above for v can be combined with any of the ranges or specific values provided earlier above for x and y.

A number of exemplary ranges for v in which v has an upper bound of up to or less than 0.5 are provided as follows: 0≤v≤0.5, 0≤v≤0.5, 0≤v<0.5, 0≤v≤0.5, 0.01≤v≤0.5, 0.01<v<0.5, 0.01≤v≤0.5, 0.01≤v≤0.5, 0.1≤v≤0.5, 0.1<v≤0.5, 0.1≤v≤0.5, 0.1<v<0.5, 0.2≤v≤0.5, 0.2≤v≤0.5, 0.2≤v≤0.5, 0.2≤v≤0.5, 0.3≤v≤0.5, 0.3<v≤0.5, 0.3≤v<0.5, and 0.3<v<0.5. Moreover, any of the ranges or specific values provided above for v can be combined with any of the ranges or specific values provided earlier above for x and y.

A number of exemplary ranges for v in which v has an upper bound of up to or less than 0.4 are provided as follows: 0≤v≤0.4, 0≤v≤0.4, 0≤v≤0.4, 0≤v≤0.4, 0.01≤v≤0.4, 0.01<v≤0.4, 0.01≤v≤0.4, 0.01≤v≤0.4, 0.1≤v≤0.4, 0.1≤v≤0.4, 0.1≤v≤0.4, 0.1≤v≤0.4, 0.2≤v≤0.4, 0.2≤v≤0.4, 0.2≤v≤0.4, 0.2≤v≤0.4, 0.3≤y≤0.4, 0.3<v≤0.4, 0.3≤v≤0.4, and 0.3<v<0.4. Moreover, any of the ranges or specific values provided above for v can be combined with any of the ranges or specific values provided earlier above for x and y.

A number of exemplary ranges for v in which v has an upper bound of up to or less than 0.3 are provided as follows: 0≤v≤0.3, 0<v≤0.3, 0≤v≤0.3, 0≤v≤0.3, 0.01≤v≤0.3, 0.01<v≤0.3, 0.01≤v≤0.3, 0.01≤v≤0.3, 0.1≤v≤0.3, 0.1≤v≤0.3, 0.1≤v<0.3, 0.1<v<0.3, 0.2≤v≤0.3, 0.2<v≤0.3, 0.2 v<0.3, and 0.2<v<0.3. Moreover, any of the ranges or specific values provided above for v can be combined with any of the ranges or specific values provided earlier above for x and y.

A number of exemplary ranges for v in which v has an upper bound of up to or less than 0.2 are provided as follows: 0≤v≤0.2, 0<v≤0.2, 0≤v≤0.2, 0<v<0.2, 0.01≤v≤0.2, 0.01<v≤0.2, 0.01≤v≤0.2, 0.01≤v≤0.2, 0.1≤y≤0.2, 0.1<v≤0.2, 0.1≤v≤0.2, and 0.1<v<0.2. Moreover, any of the ranges or specific values provided above for v can be combined with any of the ranges or specific values provided earlier above for x and y.

The variable z represents the stoichiometric (molar) amount of M³, i.e., at least one element selected from Ti, Cr, Mn, Ni, Cu, Zn, Zr, Nb, Mo, W, Ta, and Hf, present in the magnetic composition. In different embodiments, z can be, for example, 0, 0.01, 0.1, 0.2, 0.3, 0.4, 0.5, 0.6, 0.7, 0.8, 0.9, or 1, or z may have a value within a range bounded by any two of the foregoing values.

A number of exemplary ranges for z in which z has an upper bound of up to or less than 1 are provided as follows: 0≤z≤1, 0≤z<1, 0<z<1, 0≤z≤1, 0.01≤z≤1, 0.01<z≤1, 0.01≤z≤1, 0.01≤z≤1, 0.1≤z≤1, 0.1≤z≤1, 0.1≤z≤1, 0.1≤z≤1, 0.2≤z≤1, 0.2<z≤1, 0.2≤z≤1, 0.2≤z≤1, 0.3≤z≤1, 0.3≤z≤1, 0.3≤z≤1, 0.3≤z≤1, 0.4≤z≤1, 0.4≤z≤1, 0.4≤z≤1, 0.4<z<1, 0.5≤z≤1, 0.5≤z≤1, 0.5≤z≤1, 0.5≤z≤1, 0.6≤z≤51, 0.6≤z≤51, 0.6≤5z≤1, 0.6≤z≤1, 0.7≤5z≤51, 0.7≤z≤51, 0.7≤5z≤1, 0.7<z<1, 0.8≤z≤1, 0.8≤z≤1, 0.8≤z≤1, 0.8≤z≤1, 0.9≤z≤1, 0.9≤z≤1, and 0.9≤z<1. Moreover, any of the ranges or specific values provided above for z can be combined with any of the ranges or specific values provided earlier above for x, y, and v.

A number of exemplary ranges for z in which z has an upper bound of up to or less than 0.8 are provided as follows: 0≤z≤0.8, 0≤z≤0.8, 0≤z≤0.8, 0≤z≤0.8, 0.01≤z≤0.8, 0.01<z≤0.8, 0.01≤z≤0.8, 0.01≤z≤0.8, 0.1≤z≤0.8, 0.1≤z≤0.8, 0.1≤z<0.8, 0.1<z<0.8, 0.2≤z≤0.8, 0.2≤z≤0.8, 0.2≤z≤0.8, 0.2≤z≤0.8, 0.3≤z≤0.8, 0.3≤z≤0.8, 0.3≤z<0.8, 0.3<z<0.8, 0.4≤z≤0.8, 0.4≤z≤0.8, 0.4≤z≤0.8, 0.4≤z≤0.8, 0.5≤z≤0.8, 0.5≤z≤0.8, 0.5≤z≤0.8, 0.5≤z≤0.8, 0.6≤z≤0.8, 0.6≤z≤0.8, 0.6≤z<0.8, and 0.6<z<0.8. Moreover, any of the ranges or specific values provided above for z can be combined with any of the ranges or specific values provided earlier above for x, y, and v.

A number of exemplary ranges for z in which z has an upper bound of up to or less than 0.5 are provided as follows: 0≤z≤0.5, 0≤z≤0.5, 0≤z≤0.5, 0<z≤0.5, 0.01≤z≤0.5, 0.01<z≤0.5, 0.01≤z<0.5, 0.01≤z≤0.5, 0.1≤z≤0.5, 0.1<z≤0.5, 0.1≤z<0.5, 0.1<z<0.5, 0.2≤z≤0.5, 0.2≤z≤0.5, 0.2≤z≤0.5, 0.2≤z≤0.5, 0.3≤z≤0.5, 0.3<z≤0.5, 0.3≤z<0.5, and 0.3<z<0.5. Moreover, any of the ranges or specific values provided above for z can be combined with any of the ranges or specific values provided earlier above for x, y, and v.

A number of exemplary ranges for z in which z has an upper bound of up to or less than 0.4 are provided as follows: 0≤z≤0.4, 0≤z≤0.4, 0≤z≤0.4, 0≤z≤0.4, 0.01≤z≤0.4, 0.01<z≤0.4, 0.01≤z≤0.4, 0.01<z<0.4, 0.1≤z≤0.4, 0.1<z≤0.4, 0.1≤z<0.4, 0.1<z<0.4, 0.2≤z≤0.4, 0.2≤z≤0.4, 0.2≤z<0.4, 0.2≤z≤0.4, 0.3≤z≤0.4, 0.3<z≤0.4, 0.3≤z<0.4, and 0.3<z<0.4. Moreover, any of the ranges or specific values provided above for z can be combined with any of the ranges or specific values provided earlier above for x, y, and v.

A number of exemplary ranges for z in which z has an upper bound of up to or less than 0.3 are provided as follows: 0≤z≤0.3, 0≤z≤0.3, 0≤z≤0.3, 0≤z≤0.3, 0.01≤z≤0.3, 0.01≤z≤0.3, 0.01≤z≤0.3, 0.01≤z≤0.3, 0.1≤z≤0.3, 0.1≤z≤0.3, 0.1≤z<0.3, 0.1<z<0.3, 02z≤03.2≤z≤0.3, 0.2 z<0.3, and 0.2<z<0.3. Moreover, any of the ranges or specific values provided above for z can be combined with any of the ranges or specific values provided earlier above for x, y, and v.

A number of exemplary ranges for z in which z has an upper bound of up to or less than 0.2 are provided as follows: 0≤z≤0.2, 0z≤0.2, 0 z≤0.2, 0<z<0.2, 0.01≤z≤0.2, 0.01<z≤0.2, 0.01≤z≤0.2, 0.01≤z≤0.2, 0.1≤z≤0.2, 0.1≤z≤0.2, 0.1≤z<0.2, and 0.1<z<0.2. Moreover, any of the ranges or specific values provided above for z can be combined with any of the ranges or specific values provided earlier above for x, y, and v.

A number of exemplary ranges for z in which z has an upper bound of up to or less than 0.1 are provided as follows: 0≤z≤0.1, 0≤z≤0.1, 0≤z≤0.1, 0≤z≤0.1, 0.01≤z≤0.1, 0.01<z≤0.1, 0.01≤z≤0.1, 0.01≤z≤0.1, 0.05≤z≤0.1, 0.05≤z≤0.1, 0.05≤z<0.1, and 0.05<z<0.1. Moreover, any of the ranges or specific values provided above for z can be combined with any of the ranges or specific values provided earlier above for x, y, and v.

The variable w adds to the value of v, thereby serving as a possible adjustment in the amount of lanthanide present in the magnetic composition. In different embodiments, w can be, for example, 0, 0.01, 0.1, 0.2, 0.3, 0.4, 0.5, 0.6, 0.7, or 0.8, or w may have a value within a range bounded by any two of the foregoing values.

A number of exemplary ranges for w in which w has an upper bound of up to or less than 0.8 are provided as follows: 0≤w≤0.8, 0≤w≤0.8, 0≤w≤0.8, 0<w<0.8, 0.01≤w≤0.8, 0.01<w≤0.8, 0.01≤w<0.8, 0.01<w<0.8, 0.1≤w≤0.8, 0.1≤w≤0.8, 0.1≤w<0.8, 0.1<w<0.8, 0.2≤w≤0.8, 0.2≤w≤0.8, 0.2≤w≤0.8, 0.2<w≤0.8, 0.3≤w≤0.8, 0.3≤w≤0.8, 0.3≤w≤0.8, 0.3≤w≤0.8, 0.4≤w≤0.8, 0.4≤w≤0.8, 0.4≤w<0.8, 0.4<w<0.8, 0.5≤w≤0.8, 0.5<w≤0.8, 0.5≤w≤0.8, 0.5≤w<0.8, 0.6≤w≤0.8, 0.6<w≤0.8, 0.6≤w<0.8, and 0.6<w<0.8. Moreover, any of the ranges or specific values provided above for w can be combined with any of the ranges or specific values provided earlier above for x, y, v, and z.

A number of exemplary ranges for w in which w has an upper bound of up to or less than 0.5 are provided as follows: 0≤w≤0.5, 0≤w≤0.5, 0≤w<0.5, 0≤w≤0.5, 0.01≤w≤0.5, 0.01≤w≤0.5, 0.01≤w<0.5, 0.01≤w<0.5, 0.1≤w≤0.5, 0.1<w≤0.5, 0.1≤w<0.5, 0.1≤w<0.5, 0.2≤w≤0.5, 0.2≤w≤0.5, 0.2≤w≤0.5, 0.2≤w≤0.5, 0.3≤w≤0.5, 0.3<w≤0.5, 0.3≤w<0.5, and 0.3<w<0.5. Moreover, any of the ranges or specific values provided above for w can be combined with any of the ranges or specific values provided earlier above for x, y, v, and z.

A number of exemplary ranges for w in which w has an upper bound of up to or less than 0.4 are provided as follows: 0≤w≤0.4, 0≤w≤0.4, 0≤w≤0.4, 0≤w≤0.4, 0.01≤w≤0.4, 0.01≤w≤0.4, 0.01≤w≤0.4, 0.01≤w≤0.4, 0.1≤w≤0.4, 0.1<w≤0.4, 0.1≤w<0.4, 0.1<w<0.4, 0.2≤w≤0.4, 0.2<w≤0.4, 0.2≤w≤0.4, 0.2<w<0.4, 0.3≤w≤0.4, 0.3<w≤0.4, 0.3≤w<0.4, and 0.3<w<0.4. Moreover, any of the ranges or specific values provided above for w can be combined with any of the ranges or specific values provided earlier above for x, y, v, and z.

A number of exemplary ranges for w in which w has an upper bound of up to or less than 0.3 are provided as follows: 0≤w≤0.3, 0<w≤0.3, 0≤w≤0.3, 0<w<0.3, 0.01≤w≤0.3, 0.01<w≤0.3, 0.01≤w<0.3, 0.01<w<0.3, 0.1≤w≤0.3, 0.1<w≤0.3, 0.1≤w<0.3, 0.1<w<0.3, 0.2≤w≤0.3, 0.2<w≤0.3, 0.2≤w<0.3, and 0.2<w<0.3. Moreover, any of the ranges or specific values provided above for w can be combined with any of the ranges or specific values provided earlier above for x, y, v, and z.

A number of exemplary ranges for w in which w has an upper bound of up to or less than 0.2 are provided as follows: 0≤w≤0.2, 0<w≤0.2, 0≤w<0.2, 0<w<0.2, 0.01≤w≤0.2, 0.01<w≤0.2, 0.01≤w≤0.2, 0.01≤w≤0.2, 0.1≤w≤0.2, 0.1<w≤0.2, 0.1≤w<0.2, and 0.1<w<0.2. Moreover, any of the ranges or specific values provided above for w can be combined with any of the ranges or specific values provided earlier above for x, y, v, and z.

A number of exemplary ranges for w in which w has an upper bound of up to or less than 0.1 are provided as follows: 0≤w≤0.1, 0<w≤0.1, 0≤w≤0.1, 0<w<0.1, 0.01≤w≤0.1, 0.01≤w≤0.1, 0.01≤w≤0.1, 0.01<w<0.1, 0.05≤w≤0.1, 0.05<w≤0.1, 0.05≤w<0.1, and 0.05<w<0.1. Moreover, any of the ranges or specific values provided above for w can be combined with any of the ranges or specific values provided earlier above for x, y, v, and z.

In some embodiments of Formula (1), x is 0, which results in Formula (1) having the following formula: Ce_{2.7-(v+w)}M²ᵥ(Fe_{14-y}Co_{y})_{1-z}M³_{z}B, or alternatively, Ce₂₋ᵥM²ᵥ(Fe_{14-y}Co_{y})_{1-z}M³_{z}B. In further embodiments, v is 0, which may result in the following formula: Ce_{2.7-w}(Fe_{14-y}Co_{y})_{1-z}M³_{z}B, or alternatively, Ce₂(Fe_{14-y}Co_{y})_{1-z}M³_{z}B. Alternatively, v may be 1, which may result in any of the following formulas: Ce_{2.7-(v+w)}M²(Fe_{14-y} Co_{y})_{1-z}M³_{z}B, or alternatively, CeM²(Fe_{14-y}Co_{y})_{1-z}M³_{z}B. Alternatively, y may be 0, which may result in any of the following formulas: Ce_{2.7-(v+w)}M²ᵥ(Fe₁₄)_{1-z}M³_{z}B, or alternatively, Ce₂₋ᵥM²ᵥ(Fe₁₄)_{1-z}M³_{z}B, Ce_{2.7-w}(Fe₁₄)_{1-z}M³_{z}B, or Ce₂(Fe₁₄)_{1-z}M³_{z}B. Alternatively, w may be 0, which may result in any of the following formulas: Ce_{2.7-v}M²ᵥ(Fe_{14-y} Co_{y})_{1-z}M³_{z}B, Ce_{2.7}(Fe_{14-y}Co_{y})_{1-z}M³_{z}B, or Ce_{2.7}(Fe₁₄)_{1-z}M³_{z}B. Alternatively, z may be 0, which may result in any of the following formulas: Ce_{2.7-(v+w)}M²ᵥ(Fe_{14-y}Co_{y})B, or alternatively, Ce₂₋ᵥM²ᵥ(Fe_{14-y}Co_{y})B, Ce_{2.7-w}(Fe_{14-y}Co_{y})B, Ce₂(Fe_{14-y}Co_{y})B, Ce_{2.7-(v+w)}M²ᵥ(Fe₁₄)B, Ce_{2-w}M²ᵥFe₁₄B, Ce_{2.7-w}Fe₁₄B, Ce₂Fe₁₄B, Ce_{2.7-v}M²ᵥ(Fe_{14-y}Co_{y})B, Ce_{2.7}(Fe_{14-y}Co_{y})B, or Ce_{2.7}Fe₁₄B. Alternatively, z may be 1, which may result in any of the following formulas: Ce_{2.7-w}M³B, or alternatively, Ce₂M³B, Ce_{2.7-(1+w)}M²M³B, CeM²M³B, Ce_{2.7-(v+w)}M²ᵥM³B, Ce_{2-w}M²ᵥM³B, Ce_{2.7-w}M³B, Ce_{2.7-V}M²ᵥM³B, or Ce_{2.7}M³B.

In embodiments of Formula (1), v is 0, which results in Formula (1) having the following formula: (Ce₁₋ₓM¹ₓ)_{2.7-w}M²ᵥ(Fe_{14-y}Co_{y})_{1-z}M³_{z}B, or alternatively, (Ce₁₋ₓM¹ₓ)₂(Fe_{14-y} Co_{y})_{1-z}M³_{z}B. In further embodiments, x is 0, which results in the following formulas: Ce_{2.7-w}M²ᵥ(Fe_{14-y}Co_{y})_{1-z}M³_{z}B, or alternatively, Ce₂(Fe_{14-y}Co_{y})_{1-z}M³_{z}B. In other embodiments, y is 0, which results in the following formulas: (Ce₁₋ₓM¹ₓ)_{2.7-w}M²ᵥ(Fe₁₄)_{1-z}M³_{z}B, or alternatively, (Ce₁₋ₓM¹ₓ)₂(Fe₁₄)_{1-z}M³_{z}B, Ce_{2.7-w}M²ᵥ(Fe₁₄)_{1-z}M³_{z}B, or Ce₂(Fe₁₄)_{1-z}M³_{z}B. In other embodiments, w is 0, which results in the following formulas: (Ce₁₋ₓM¹ₓ)_{2.7}M²ᵥ(Fe_{14-y}Co_{y})_{1-z}M³_{z}B, Ce_{2.7}M²ᵥ(Fe_{14-y}Co_{y})_{1-z}M³_{z}B, (Ce₁₋ₓM¹ₓ)_{2.7}M²(Fe₁₄)_{1-z}M³_{z}B, or Ce_{2.7}M²ᵥ(Fe₁₄)_{1-z}M³_{z}B. In other embodiments, z is 0, which results in the following formulas: (Ce₁₋ₓM¹ₓ)_{2.7-w}M²(Fe_{14-y}Co_{y})B, (Ce₁₋ₓM¹ₓ)₂(Fe_{14-y}Co_{y})B, Ce_{2.7-w}M²ᵥ(Fe_{14-y}Co_{y})B, Ce₂(Fe_{14-y}Co_{y})B, (Ce₁₋ₓM¹ₓ)_{2.7-w}M²ᵥFe₁₄B, (Ce₁₋ₓM¹ₓ)₂Fe₁₄B, Ce_{2.7-w}M²ᵥFe₁₄B, (Ce₁₋ₓM¹ₓ)_{2.7}M²ᵥ(Fe_{14-y}Co_{y})B, Ce_{2.7}M²ᵥ(Fe_{14-y}Co_{y})B, (Ce₁₋ₓM¹ₓ)_{2.7}M²Fe₁₄B, or Ce_{2.7}M²ᵥFe₁₄B.

In other embodiments of Formula (1), v is 1, which results in Formula (1) having the following formula: (Ce₁₋ₓM¹ₓ)_{2.7-(1+w)}M²(Fe_{14-y}Co_{y})_{1-z}M³_{z}B, or alternatively, (Ce₁₋ₓM¹ₓ)₂M²(Fe_{14-y}Co_{y})_{1-z}M³_{z}B. In further embodiments, x is 0, which results in the following formulas: Ce_{2.7-(1+w)}M²(Fe_{14-y}Co_{y})_{1-z}M³_{z}B, or alternatively, Ce₂M²(Fe_{14-y}Co_{y})_{1-z}M³_{z}B. In other embodiments, y is 0, which results in the following formulas: (Ce₁₋ₓM¹ₓ)_{2.7-(1+w)}M²(Fe₁₄)_{1-z}M³_{z}B, or alternatively, (Ce₁₋ₓM¹ₓ)₂M²(Fe₁₄)_{1-z}M³_{z}B, Ce_{2.7-(1+w)}M²(Fe₁₄)_{1-z} M³_{z}B, or Ce₂M²(Fe₁₄)_{1-z}M³_{z}B. In other embodiments, w is 0, which results in the following formulas: (Ce₁₋ₓM¹ₓ)_{1.7}M²(Fe_{14-y}Co_{y})_{1-z}M³_{z}B, Ce_{1.7}M²(Fe_{14-y}Co_{y})_{1-z}M³_{z}B, (Ce₁₋ₓM¹ₓ)_{1.7}M²(Fe₁₄)_{1-z}M³_{z}B, or Ce_{1.7}M²(Fe₁₄)_{1-z}M³_{z}B. In other embodiments, z is 0, which results in the following formulas: (Ce₁₋ₓM¹ₓ)_{2.7-(1+w)}M²(Fe_{14-y}Co_{y})B, (Ce₁₋ₓM¹ₓ)₂M²(Fe_{14-y} Co_{y})B, Ce_{2.7-(1+w)}M²(Fe_{14-y}Co_{y})B, Ce₂M²(Fe_{14-y}Co_{y})B, (Ce₁₋ₓM¹ₓ)_{2.7-(1+w)}M²Fe₁₄B, (Ce₁₋ₓM¹ₓ)₂M²Fe₁₄B, Ce_{2.7-(1+w)}M²Fe₁₄B, Ce₂M²Fe₁₄B, (Ce₁₋ₓM¹ₓ)_{1.7}M²Fe_{14-y}Co_{y}B, Ce_{1.7}M²Fe_{14-y} Co_{y}B, (Ce₁₋ₓM¹ₓ)_{1.7}M²Fe₁₄B, or Ce_{1.7}M²Fe₁₄B.

In embodiments of Formula (1), y is 0, which results in Formula (1) having the following formula: (Ce₁₋ₓM¹ₓ)_{2.7-(v+w)}M²ᵥ(Fe₁₄)_{1-z}M³_{z}B, or alternatively, (Ce₁₋ₓM¹ₓ)₂₋ᵥ M²ᵥ(Fe₁₄)_{1-z}M³_{z}B. In further embodiments, x is 0, which results in the following formulas: (Ce)_{2.7-(v+w)}M²ᵥ(Fe₁₄)_{1-z}M³_{z}B, or alternatively, (Ce)₂₋ᵥM²ᵥ(Fe₁₄)_{1-z}M³_{z}B. In other embodiments, w is 0, which results in the following formulas: (Ce₁₋ₓM¹ₓ)_{2.7-v}M²ᵥ(Fe₁₄)_{1-z}M³_{z}B or (Ce)_{2.7-v}M²ᵥ(Fe₁₄)_{1-z}M³_{z}B. In other embodiments, z is 0, which results in the following formulas: (Ce₁₋ₓM¹ₓ)_{2.7-(v+w)}M²ᵥFe₁₄B, (Ce₁₋ₓM¹ₓ)₂₋ᵥM²ᵥFe₁₄B, (Ce)_{2.7-(v+w)}M²ᵥFe₁₄B, (Ce)₂₋ᵥM²ᵥFe₁₄B, (Ce₁₋ₓM¹ₓ)_{2.7-v}M²ᵥFe₁₄B, or (Ce)_{2.7-v}M²ᵥFe₁₄B.

In embodiments of Formula (1), z is 0, which results in Formula (1) having the following formula: (Ce₁₋ₓM¹ₓ)_{2.7-(v+w)}M²(Fe_{14-y}Co_{y})B, or alternatively, (Ce₁₋ₓM¹ₓ)₂₋ᵥM²ᵥ(Fe_{14-y}Co_{y})B. In further embodiments, x is 0, which results in the following formulas: (Ce)_{2.7-(v+w)}M²ᵥ(Fe_{14-y}Co_{y})B, or alternatively, (Ce)₂₋ᵥM²ᵥ(Fe_{14-y}Co_{y})B. In other embodiments, w is 0, which results in the following formulas: (Ce₁₋ₓM¹ₓ)_{2.7-v}M²ᵥ(Fe_{14-y} Co_{y})B or (Ce)_{2.7-v}M²ᵥ(Fe_{14-y}Co_{y})B. In other embodiments, y is 0, which results in the following formulas: (Ce₁₋ₓM¹ₓ)_{2.7-(v+w)}M²ᵥFe₁₄B, (Ce₁₋ₓM¹ₓ)₂₋ᵥM²ᵥFe₁₄B, (Ce)_{2.7-(v+w)}-M²ᵥFe₁₄B, (Ce)₂₋ᵥM²ᵥFe₁₄B, (Ce₁₋ₓM¹ₓ)_{2.7-v}M²ᵥFe₁₄B, or (Ce)_{2.7-v}M²ᵥFe₁₄B.

In embodiments of Formula (1), z is 1, which results in Formula (1) having the following formula: (Ce₁₋ₓM¹ₓ)_{2.7-(v+w)}M²ᵥM³B, or alternatively, (Ce₁₋ₓM¹ₓ)₂₋ᵥM²ᵥM³B. In further embodiments, x is 0, which results in the following formulas: (Ce)_{2.7-(v+w)}M²ᵥM³B, or alternatively, (Ce)₂₋ᵥM²ᵥM³B. In other embodiments, w is 0, which results in the following formulas: (Ce₁₋ₓM¹ₓ)_{2.7-v}M²ᵥM³B or (Ce)_{2.7-v}M²ᵥM³B.

Notably, any of the various and alternative formulas provided in this application may have x, y, z, v, and w variables independently selected from among any of the ranges or specific values provided anywhere in this application.

In further particular embodiments, the magnetic composition may have one of following formulas: Ce₂₋ₓLaₓ(Fe_{14-y}Co_{y})_{1-z}M³_{z}B, or more particularly Ce₂₋ₓLaₓFe_{14-y}Co_{y}B, preferably wherein 0≤x≤2, 0≤y≤3, and 0≤z≤1. In other particular embodiments, the magnetic composition may have one of the following formulas: Ce₂₋ₓZrₓ(Fe_{14-y}Co_{y})_{1-z}M³_{z}B, Ce₂₋ₓZrₓ(Fe_{14-y}Co_{y})B, Ce₂₋ₓZrₓFe₁₂Co₂B, or Ce₂₋ₓZrₓ(Fe₁₂Co₂)_{1-z}M³_{z}B. In other particular embodiments, the magnetic composition may have one of the following formulas: (Ce₁₋ₓXₓ)₂(Fe_{14-y}Co_{y})_{1-z}M³_{z}B, or more particularly, (Ce₁₋ₓXₓ)₂(Fe_{14-y}Co_{y})B, or more particularly, (Ce₁₋ₓXₓ)₂Fe₁₄B, or more particularly, (Ce_{0.75}X_{0.25})₂Fe₁₄B or (Ce_{0.5}Bi_{0.5})₂Fe₁₄B (X=Sn, Sb, Pb, Bi, La or Zr or more particularly X=Sn, Sb and Bi) and 0≤x<1, or any of the particular x values provided anywhere else in this disclosure. In other particular embodiments, the magnetic composition may have one of the following formulas: LaCeFe_{12.7}Co_{1.3}B, (La_{0.5}Ce_{0.5})_{1.9}Zr_{0.1}Fe₁₂Co₂B, or Ce₂Fe_{12.7}Co_{1.3}B. All variables x, y, and z in any of the above formulas can independently be any of the ranges or specific values provided anywhere in this application.

The permanent magnet may, in some embodiments, be denoted as a bulk or macroscopic object, which is larger than a microscopic or nanoscopic object. The permanent magnet considered herein typically has a size of at least 1 millimeter (mm) for at least one of the dimensions of the permanent magnet. In some embodiments, the permanent magnet may have a size of at least 1 centimeter (cm) for at least one of its dimensions. In other embodiments, the permanent magnet may have a size in the micron range, such as obtained by grinding a larger object of the same magnetic composition. The micron-sized magnetic object may be precisely, at least, or more than, for example, 1, 2, 5, 10, 20, 50, or 100 microns.

In some embodiments, the permanent magnet has a planar (layer) shape, generally with a thickness of up to or less than 10 mm, e.g., up to or less than 5, 4, 3, 2, or 1 mm. The magnet may, in one embodiment, have no edges or corners, such as in a smoothened disk or sphere. In other embodiments, the magnet has at least one edge and no corners, such as in an edged disk. In yet other embodiments, the magnet has at least one corner, such as in a parallelepiped, such as a cube, block, or layer shape, or other polyhedral shape.

The magnetic composition according to Formula (1) or sub-formula or alternative formula thereof may have one or more acceptable or exceptional magnetic properties. Some examples of magnetic properties include Curie point, energy product, coercivity, magnetization, and anisotropy field. The magnetic composition may exhibit a Curie point greater than 585 K, and in some embodiments, the Curie point may be at least or above 600 K, 650 K, 700 K, 725 K, or 750 K. The magnetic composition may exhibit an energy product (magnetic strength) of at least or above 5, 10, or 15 MG-Oe (where MG-Oe=Megagauss-Oersted), and in some embodiments, the energy product is at least or above 20, 25, 30, 35, 40, 45, 50, or 55 MG-Oe. The magnetic composition may exhibit a coercivity of at least or above 2, 3, 4, or 5 kOe, and in some embodiments, the coercivity may be at least or above 6, 8, 10, 12, 15, 20, 25, 30, 35, or 40 kOe. The magnetic composition may exhibit a magnetization of at least or above 0.8 or 0.9 T (where T=Tesla), and in some embodiments, the magnetization may be at least or above 1, 1.1, 1.2, 1.3, 1.4, 1.5, or 1.6 T (room temperature values). To convert T to kilogauss (kG), multiply by the foregoing values by 10. The magnetic composition may exhibit an anisotropy field of at least 0.5 or 1 T, and in some embodiments, the anisotropy field is at least or above 2, 3, 4, 5, 6, 7, 8, 9, 10, 11, or 12 T (or 5-120 kOe).

In another aspect, the present disclosure is directed to a method for producing the above-described permanent magnet. Any of the known methods for producing alloys containing a combination of lanthanide and transition metal elements can be used for producing compositions according to Formula (1) or sub-formula or alternative formula thereof. In a typical method, stoichiometric quantities of all elements to be included in the formula are melted together (e.g., by arc-melting, vacuum melting, or plasma melting) followed by annealing the melt, typically under a low-oxygen or completely inert gas atmosphere. The inert gas may be, e.g., argon or nitrogen. The annealing step may employ a temperature of, typically, at least 700° C., 800° C., 900° C., or 1000° C., for a period of at least 24 hours, 48 hours, 72 hours, or a week.

Examples have been set forth below for the purpose of illustration and to describe certain specific embodiments of the invention. However, the scope of this invention is not to be in any way limited by the examples set forth herein.

### Examples

### Overview

The following experimental work examines magnetic compositions based on Ce₂Fe₁₄B with Co, La of Zr substitutions. Along with the Co substitutions on Fe, partial Zr substitution increases the impurity phase and has little effect on the Curie point and Mₛ. While, without the loss of anisotropy field, the substitution of La on Ce increases the Curie temperature and saturation magnetization, which may produce an estimated energy product of 48 MG-Oe. For example, LaCeFe_{12.7}Co_{1.3}B can function as a critical-element-free, high-performance permanent magnet. While neither La nor Zr substitution improves the magnetic anisotropy of Ce₂Fe₁₄B, first principles calculations can be used to study the origin of magnetic anisotropy in Ce₂Fe₁₄B. These findings suggest that, contrary to the prevailing view of cerium in Ce₂Fe₁₄B as non-magnetic and therefore not contributing to magnetic anisotropy, the magnetic anisotropy in Ce₂Fe₁₄B is comparably contributed by the Ce and Fe atoms, where the Ce-projected magnetic anisotropy is predominately provided by the Ce atoms in 4g site.

By providing the atom substitution on the “non-contributing” 4f-site Ce atoms (the energetically favorable site for Bi), a considerable (almost three times) promotion of magnetic anisotropy in Bi-substituted Ce₂Fe₁₄B was found while slightly increasing the already strong magnetization. These experimental results reveal the great potential of La—Co co-substitution and Bi substitution on developing Ce₂Fe₁₄B-based low-cost and critical-element-free permanent magnet.

Accordingly, in one aspect, the technologies described herein provides a magnet composition comprising Ce₂₋ₓLaₓFe_{14-y}Co_{y}B wherein 0≤x≤2 and 0≤y≤3.

In the present work, additional elements were added to enhance properties, such as, for example, yield coercivity and a square hysteresis loop. Additions may include, for example, of up to 6 weight percent of any of the following elements, which could also be used in combination:
Ti, Cr, Mn, Ni, Cu, Zn (A1)
Zr, Nb, Mo (A2)
W, Ta, Hf (A3)

In another aspect, the above elements can substitute for Fe and Co. In particular aspects, the magnet composition has the formula Ce₂₋ₓLaₓ(Fe_{14-y}Co_{y})_{1-z}A_{z}B, where the variable A represents A1, A2 and/or A3, as shown above, and wherein 0≤x≤2 and 0≤y≤3, and 0≤z≤1. In some embodiments, the magnets described herein can further comprise sintering aids. Sintering aids include, but are not limited to, for example, gallium. The sintering aids can be used, typically in concentrations under 1% wt. In some embodiments, sintering aids are excluded.

### Preparation of Ce₂Fe₁₄B-Based Materials

The Ce₂Fe₁₄B-based materials were prepared by conventional arc melting and post annealing process. The starting materials were La, Ce, Zr (99.8%), Fe pieces (99.999%), Co ingots (99.999%), and B pieces (99.5%). The starting materials in the desired ratio were arc melted in an argon-arc furnace with a water-cooled hearth and a non-consumable tungsten electrode. The ingot was melted four or five times to ensure homogeneity and then sealed in a quartz tube under vacuum. The ampoule was then kept in a box furnace at 920° C. for 15 days. The above annealing temperature and time were found to yield samples with the highest fraction of 2-14-1 phase. After the long-term annealing, the ampoule was quenched in ice water. Room temperature x-ray powder diffraction measurements were performed using a diffractometer and a position sensitive detector using monochromated Cu Kα1 radiation.

The field dependence of magnetization was measured at room temperature for both aligned powder and a small piece of annealed polycrystalline ingot. Fine powder was aligned with epoxy inside of a capsule using a procedure described previously (B. C. Sales, Sci. Rep. 4, 7024 (2014)). The magnetic ordering temperature was determined using a Perkin-Elmer 7 series thermogravimetric analyzer (TGA) with a permanent magnet positioned right above the sample. A dramatic mass change is expected at the Curie temperature because the force exerted on the sample by the magnet disappears above the Curie temperature.

The calculations were performed by using the all-electron-density functional code WIEN2k (E. Sjöstedt et al., Solid State Commun., 114, 15 (2000)) with the generalized-gradient approximation of Perdew, Burke and Ernzerhof (J. P. Perdew et al., Phys. Rev.

Lett., 77, 3865, 1996). The formation enthalpies and decomposition enthalpies of substituted Ce₂Fe₁₄B were calculated according to the Vienna Ab initio Simulation Package (G. Kresse et al., Comput. Mater. Sci., 6, 15, 1996).

### Results and Discussion

Experimental analysis on Ce₂Fe₁₄B with Co, La and Zr substitution. In general, the Curie point of R₂Fe₁₄B can be improved by Co substitution for Fe. The effect of partial substitution of Ce by La and Zr in Ce₂Fe₁₄₋ₓCoₓB with x=1.3 or 2.0 was also studied.

According to the X-ray powder diffraction of Ce₂₋ₓZrₓFe₁₂Co₂B collected at room temperature, for x=0, Ce₂Fe₁₂Co₂B is the majority phase with a small fraction of Ce₂Fe₁₇ that could be barely resolved by the diffraction measurement. The lattice parameters determined from Rietveld refinement are a=8.7509(10) Å and c=12.0824(16) Å, consistent with previous reports (T. Wang et al., J. Magn. Magn. Mater. 460, 95, 2018). Partial substitution of Ce by Zr significantly increases the fraction of Ce₂Fe₁₇. The fraction of Ce₂Fe₁₇ increases from 13% wt for Ce_{1.9}Zr₀₁Fe₁₂Co₂B to 64% wt for Ce_{1.8}Zr_{0.2}Fe₁₂Co₂B. The lattice parameters for the 2-14-1 phase are a=8.7481(4) Å and c=12.0692(6) Å for both x=0.1 and 0.2.

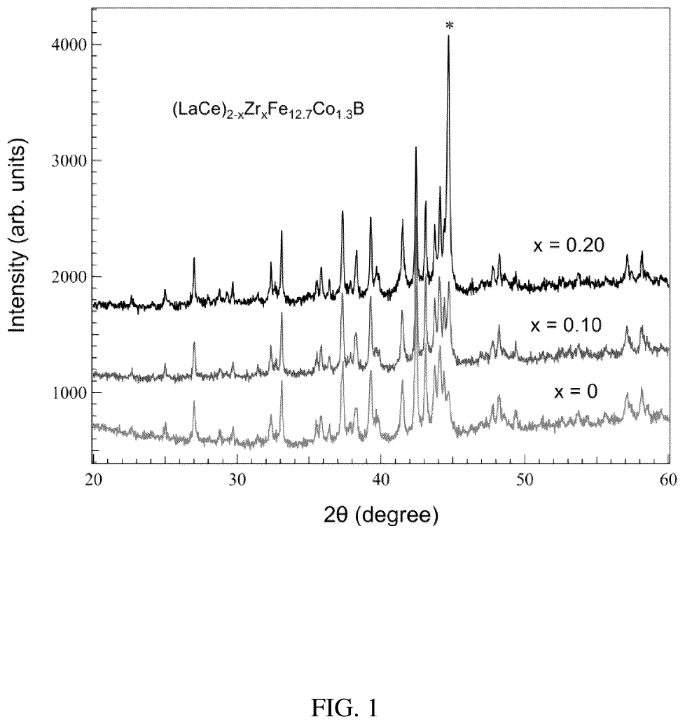

Replacing half of Ce by La seems to stabilize the desired 2-14-1 phase. As shown in the X-ray powder diffraction of (LaCe)₂₋ₓZrₓFe_{12.7}Co_{1.3}B (x=0.0. 0.1 or 0.2) in FIG. 1, 2-14-1 is the majority phase in both (LaCe)₂₋ₓZrₓFe_{12.7}Co_{1.3}B samples with x=0.1 and 0.2 and the impurity is Fe instead of Ce₂Fe₁₇. There are 11% wt of Fe(Co) impurity in x=0.1 and this impurity increases to 26% wt with more Zr (x=0.2) in the starting materials. Partial substitution of Ce by La expands the c-lattice of the 2-14-1 phase. The lattice parameters are a=8.7472(6) Å, c=12.2244(10) Å for x=0.1, to a=8.7773(6) Å, c=12.193(1) Å for x=0.2, as determined from the Rietveld refinement of the room temperature powder diffraction patterns. Overall, partial substitution of Zr increases the amount of impurity phase, and La substitution stabilizes the desired 2-14-1 phase.

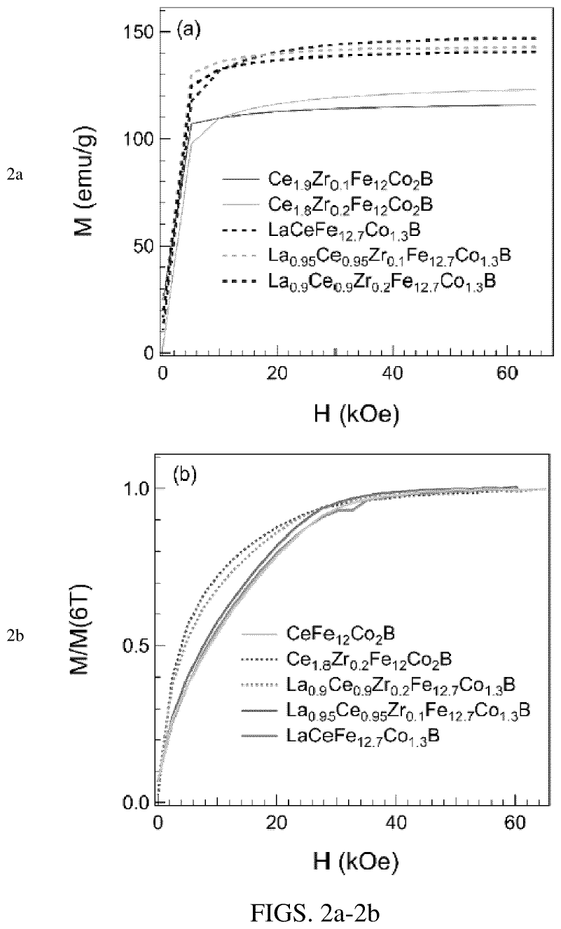

The magnetic ordering temperature, i.e., the Curie temperature, was determined by measuring the magnetic thermogravimetric analyses. The Curie temperature for Ce₂₋ₓ ZrₓFe₁₂Co₂B is at 285° C. and the partial substitution of Ce by Zr has little effect on Curie temperature. With half of Ce replaced by La, the Curie point is increased to 315° C. for (La_{0.5}Ce_{0.5})_{1.9}Zr_{0.1}Fe₁₂Co₂B, which is higher than the achieved highest Curie point of ˜490 K in Ce₂Fe₁₄B substituted just by La (Z. Li et al., J. Magn. Magn. Mater. 505, 166747, 2020). This 315° C. value is in fact equivalent to that of Nd₂Fe₁₄B. FIG. 2a shows the field dependence of magnetization to determine the Mₛ at room temperature. Mₛ for Ce₂Fe₁₂Co₂B is about 120 emu/g, which is comparable to that of Ce₂Fe₁₄B reported previously (T. Wang et al., J. Alloys Compd. 763, 916, 2018). Partial substitution of Ce by Zr in Ce₂₋ₓZrₓFe₁₂Co₂B has little effect on Mₛ. In contrast, replacing half of Ce by La increases Mₛ to 145 emu/g (or 1.38 T) in LaCeFe_{12.7}Co_{1.3}B. It should be noted that further introducing Zr in the La—Ce compound also has little effect on Mₛ (see the (LaCe)₂₋ₓZrₓFe_{12.7}Co_{1.3}B (x=0.1 or 0.2) in FIG. 2a). Meanwhile, the Mₛ of 1.38 T in LaCeFe_{12.7}Co_{1.3}B at room temperature is higher than the Mₛ of ˜1.15 T in LaCeFe₁₄B at 300 K [15], implying the importance of La and Co co-substitutions.

The anisotropy field for these La- and Zr-substituted compounds was also studied. FIG. 2b shows the field dependence of magnetization of aligned powder in order to determine the anisotropy field. It can be found that the anisotropy field remains the same when half of the Ce is replaced by La. With partial substitution of Ce by Zr, H_{A} is gradually suppressed. Given these experimental results, the partial Zr substitution increases the impurity phase and has little effect on the Curie point and Mₛ. At the same time, the substitution of La improves the Curie temperature and Mₛ without loss of anisotropy field, which may produce an energy product as high as 48 MG-Oe as estimated by (Mₛ)²/4. These properties indicate the viability of LaCeFe_{12.7}Co_{1.3}B as a potential high-performance permanent magnet without critical elements and only 7 weight percent of cobalt.

Origin of magnetic anisotropy in Ce₂Fe₁₄B. Although the permanent magnetic properties in Ce₂Fe₁₄B was achieved with La and Co co-substitution, it should be noted that neither La nor Zr substitution improves the magnetic anisotropy of Ce₂Fe₁₄B. Only the Zr substitution on Ce has ever been reported to enhance the anisotropy of Ce₂Fe₁₄B and other R₂Fe₁₄B compounds (e.g., T. Capehart et al., J. Appl. Phys. 73, 6476, 1993), which is contrary to our experimental results. These experimental results reflect the challenge of modulating the magnetic anisotropy of Ce₂Fe₁₄B. Here, theoretical calculations were employed to further elucidate Ce₂Fe₁₄B.

In order to confirm the magnetic calculations in Ce₂Fe₁₄B, the magnetization and magnetic anisotropy were first calculated, and this was compared with the experimental results. The calculated magnetization was 1.53 T and magnetic anisotropy was found to be 1.42 MJ/m³. On this basis, an anisotropy field H_{A} of 2.34 T was obtained from the relationship of μ₀H_{A}=2μ₀K₁/Mₛ. In previously reported experiments (J. F. Herbst et al., Rev. Mod. Phys., 63, 819, 1991), the magnetization of 1.47 T and anisotropy field of 2.6 T are measured at 4 K in Ce₂Fe₁₄B. It can be seen that the calculated magnetization of 1.53 T and anisotropy field of 2.34 T are relatively close to the related experimental values. Thus, the present calculations should be reliable for further elucidating the origin of magnetic anisotropy in Ce₂Fe₁₄B.

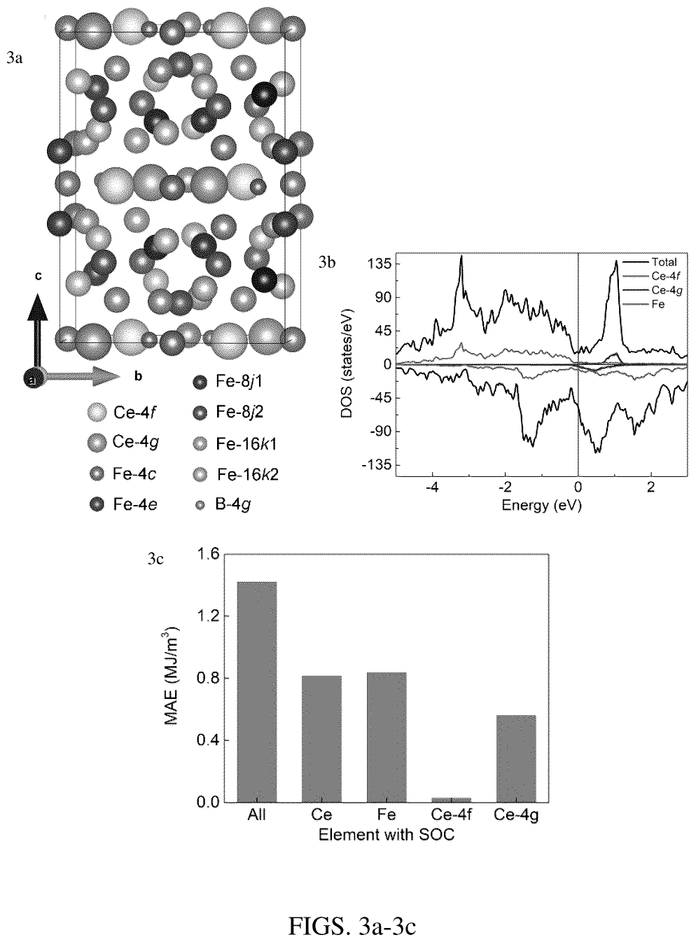

As shown in the side-view geometry structures of Ce₂Fe₁₄B in FIG. 3a, Ce₂Fe₁₄B holds two inequivalent kinds of Ce, which lies in the 4f and 4g sites. Here, the two kinds of Ce are denoted as Ce-4f and Ce-4g. The total and projected density of states (DOS) in Ce₂Fe₁₄B are shown in FIG. 3b. It is found that majority of the f-orbital states are located above the Fermi level, which is associated with the smaller number of 4f electrons in Ce, as compared with other rare earth elements. In order to analyze the origin of magnetic anisotropy in Ce₂Fe₁₄B, the second-variational method was employed to switch on the SOC for specific atoms, calculating the corresponding atom-projected MAE. As displayed in FIG. 3c, the MAE in Ce₂Fe₁₄B is comparably contributed by the Ce and Fe atoms. Then, the MAE of Ce is predominantly contributed by Ce atoms in the 4g site, which is 18 times larger than the MAE contributed by Ce-4f. Such a phenomenon is similar to that observed in Nd₂Fe₁₄B (D. Hasket et al., Phys. Rev. Lett., 95, 217207, 2005). However, as shown in FIG. 3b, the f-orbital DOS of inequivalent Ce-4f and Ce-4g are highly similar with each other.

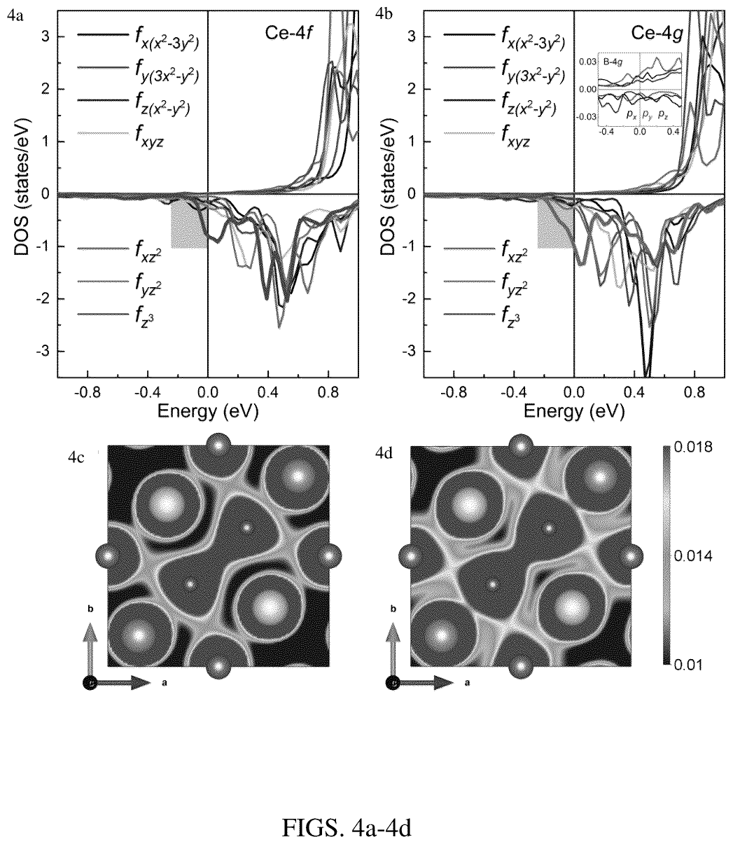

Given the inequivalent sites and dramatically different MAE contribution of Ce-4f and Ce-4g atoms, the partial DOS projected on the two kinds of Ce atoms can be further calculated, with the results shown in FIGS. 4a and 4b. It should be noted that the sum of Ce- and Fe-contributed MAE is 1.65 MJ/m³, which is slightly larger, although comparable, to the MAE of 1.42 MJ/m³ calculated with SOC in all of the atoms. The added Ce-4f- and Ce-4g-contributed MAE of 0.59 MJ/m³ is also different from the Ce-contributed MAE of 0.82 MJ/m³. The foregoing phenomenon may be due to the inaccurate orbital distribution as part of atoms are employed with SOC. The differences between the summed MAE and directly calculated MAE are 14% and 28% in the two cases. Thus, although the atom-projected MAE indicates the presence of cross-terms in the magnetic anisotropy, it is still helpful to analyze the origin of magnetic anisotropy in Ce₂Fe₁₄B.

In FIGS. 4a and 4b, the f-projected DOS is very different in Ce-4f and Ce-4g atoms, especially around the Fermi level. In Ce-4f atom, the maximum occupation near the Fermi level comes from the f_{z3} states, as shown in the bold green line in FIG. 4a. However, in the Ce-4g atom, the f_{xz2} states contributed predominately to the occupied f states (see the bold magenta line in FIG. 4b). Meanwhile, as shown in the gray section in FIGS. 4a and 4b, the f_{xz2}-projected DOS in the Ce-4g atom is also larger than the f_{z3}-projected DOS in the Ce-4f atom, underlying that Ce-4f atom contains more f electrons than the Ce-4g atom. These results are consistent with the mixed valence of Ce demonstrated in some experiments. The more f electrons provide foundation for achieving the large magnetic anisotropy in Ce-4g atom. Besides, it is noted that the f_{xz2} state in Ce-4g atom is mainly occupied in the energy interval of [E_{F}-0.2 eV, E_{F}], where E_{F} denotes the Fermi level. However, in that energy window, the p-orbital DOS of B atom mainly comes from the pₓ orbital, which is capable of hybridizing with the f_{xz2} state in the Ce-4g atom.

For checking the B—Ce interaction, the charge density for Ce₂Fe₁₄B can be plotted, as shown in FIGS. 4c and 4d. It can be found that the charge densities between B and Ce-4g atoms are larger than that between B and Ce-4f atoms. B atoms prefer to interact with Ce-4g atoms by orbital hybridization, which is consistent with the discussed DOS results. Also, the distance between B and its nearest Ce-4f atom is 3.26 Å, which is larger than the distance of 2.89 Å between B and its nearest Ce-4g atom. The preferred interaction between B and Ce-4g is favored by such structure feature.

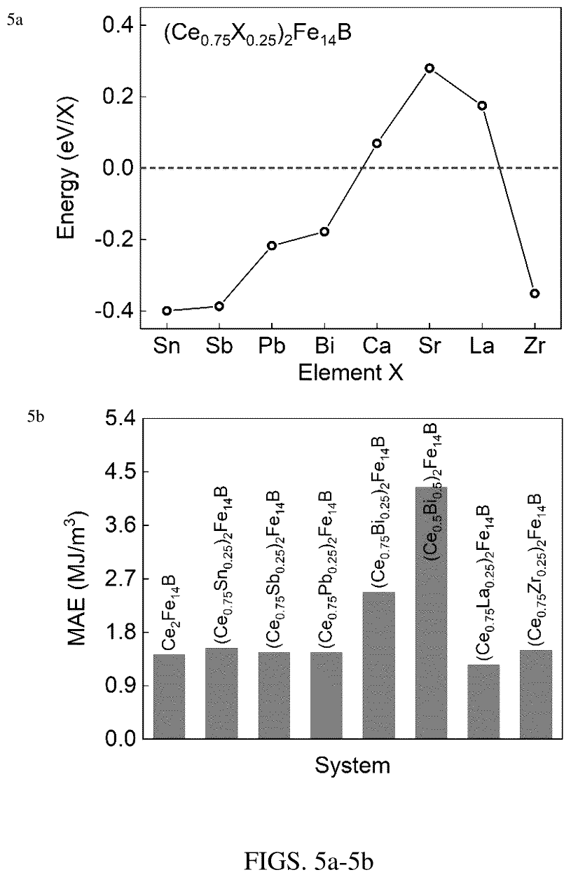

Magnetic anisotropy improved by 4f-site atom substitution. According to the atom-projected MAE in FIG. 3a, only a small portion of Ce-projected magnetic anisotropy in Ce₂Fe₁₄B originates from the Ce-4f site. Thus, with the aim of improving the magnetic anisotropy in Ce₂Fe₁₄B, atom substitution for the Ce-4f site was attempted. In this work, Sn, Sb, Bi, Ca and Sr were considered. For determining the preferential site of introduced atoms, the total energies E_{4f} (E_{4g}) of (Ce_{0.75}X_{0.25})₂Fe₁₄B (X=Sn, Sb, Bi, Ca or Sr) were calculated, as the X atom occupies the 4f (4g) site of rare earth atom. The relative energy of the E_{4f} with respect to E_{4g} reflects the preference sites of the X atom, where a negative (positive) value of relative energy indicates the preferred 4f (4g) site. The symmetry of Ce₂Fe₁₄B is not damaged by the atom substitution. As shown in FIG. 5a, differently from Ca, Sr, or La, the Sn, Sb, Pb and Bi atoms prefer to occupy the 4f site. Such a phenomenon should be associated with the atomic volumes. For reference, the atomic volumes of Ce, Sn, Sb, Pb, Bi, Ca, Sr, La and Zr are 20.69, 16.29, 18.19, 18.26, 21.31, 26.20, 33.94, 22.39 and 14.02 cm³/mol at atmospheric pressure and room temperature (C. N. Singman, J. Chem. Educ. 61, 137, 1984). Thus, it is noted that Sn, Sb, Pb, Bi and Zr atoms with smaller or comparable atomic volumes than Ce prefer to occupy the 4f site. Then, Ca, Sr and La atoms with larger atomic volumes than Ce show a preference for the 4g site. The atomic-volume-related preference site is attributed to the structure of Ce₂Fe₁₄B. In the 2:14:1 structure, the Ce-4f and Ce-4g atoms are located in different Fe environments with six inequivalent Fe sites (FIG. 3a). For the Ce-4f atom, its distances with the nearest Fe atoms in 4c, 4e and 16k2 sites are 3.11, 3.20 and 3.04 Å respectively, which are smaller than the corresponding distances (3.37, 4.63 and 3.26 Å) of the Ce-4g atom with its nearest Fe atoms in 4c, 4e and 16k2 sites. As compared with the 4f site, the 4g site provides a larger space with a large distance between Fe atoms. Hence, in substituted Ce₂Fe₁₄B, the atom with a larger volume than Ce prefers to occupy the 4g site.

Next, the magnetic properties of (Ce_{0.75}X_{0.25})₂Fe₁₄B (X=Sn, Sb, Pb, Bi, La or Zr) were explored, where X atoms, except the La atom, occupy the 4f site. As shown in FIG. 5b, the magnetic anisotropy of Ce₂Fe₁₄B is slightly improved in the Sn-, Sb-, Pb- and Zr-substituted cases, with percentage of less than 7%. The magnetic anisotropy in Ce₂Fe₁₄B with La substitution is even smaller than pristine Ce₂Fe₁₄B, which should be related to the 4g-sited occupation of La. However, the MAE of (Ce_{0.75}Bi_{0.25})₂Fe₁₄B reaches 2.48 MJ/m³, which is 70% larger than the MAE in pristine Ce₂Fe₁₄B. Given that the Bi substitution is effective on improving magnetic anisotropy, the Bi content was further increased to be (Ce_{0.5}Bi_{0.5})₂Fe₁₄B, where all of the Bi atoms occupy the 4f site. It turns out that the MAE in (Ce_{0.5}Bi_{0.5})₂Fe₁₄B can be up to 4.24 MJ/m³, which is almost three times of the magnetic anisotropy in pristine Ce₂Fe₁₄B. The atom-projected MAE was further calculated for (Ce_{0.5}Bi_{0.5})₂Fe₁₄B, where the Bi-, Ce- and Fe-projected MAE are 3.40, 0.63 and 50 MJ/m³ respectively. The large MAE contribution of Bi atoms should be associated with its strong SOC, which is scaled approximately by Z⁴ (Z=atomic number) (C. Du et al., Phys. Rev. B, 90, 140407, 2014). Moreover, in the order of listed systems in FIG. 5b, the magnetizations of (Ce_{0.75}X_{0.25})₂Fe₁₄B (X=Sn, Sb and Bi) and (Ce_{0.5}Bi_{0.5})₂Fe₁₄B are 1.56, 1.58, 1.58 and 1.64 T respectively, which are close to the 1.53 T in Ce₂Fe₁₄B. Moreover, on the basis of 4.24 MJ/m³ K₁ and 1.64 T magnetization in (Ce_{0.5}Bi_{0.5})₂Fe₁₄B, one can get the magnetic hardness parameter κ of 1.41, which is greater than the unity and the κ of 0.88 in Ce₂Fe₁₄B. These magnetic properties indicate that (Ce_{0.5}Bi_{0.5})₂Fe₁₄B can function as an inexpensive permanent magnet.

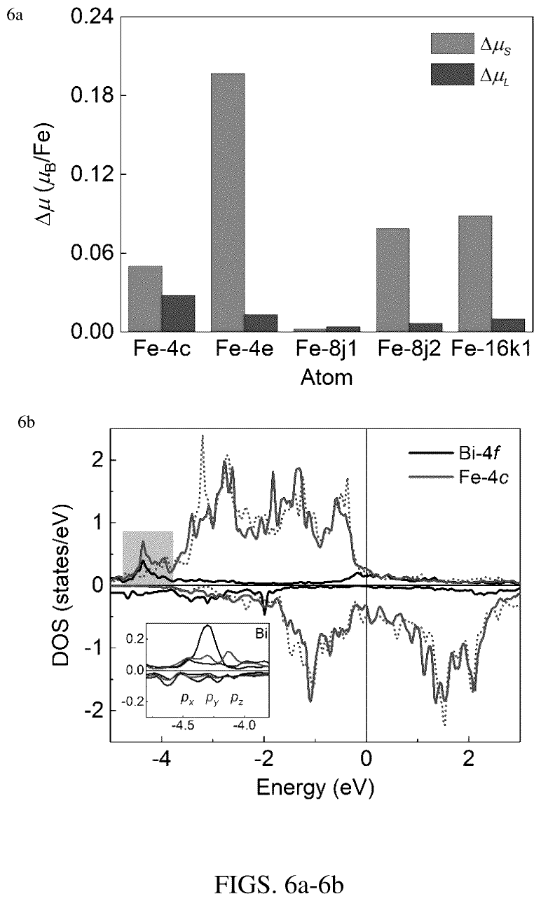

It should be noted that atom substitution in the rare earth 4f site does not decrease the magnetization in Ce₂Fe₁₄B. On the contrary, the introduced Bi atoms slightly increase the magnetization of Fe atoms. Table I below lists the atomic spin and orbital moments of (Ce_{0.5}Bi_{0.5})₂Fe₁₄B and Ce₂Fe₁₄B. The magnetic moment differences of the atomic spin (orbital) moment in (Ce_{0.5}Bi_{0.5})₂Fe₁₄B and Ce₂Fe₁₄B are defined as Δμₛ and Δμ_{L}, as displayed in FIG. 6a. All the spin and orbital moments of Fe atoms in (Ce_{0.5}Bi_{0.5})₂Fe₁₄B are larger than that in Ce₂Fe₁₄B; Fe-4e shows the maximum Δμₛ, and Fe-4c shows the maximum Δμ_{L}. The increased magnetization in (Ce_{0.5}Bi_{0.5})₂Fe₁₄B may be related with the d-p hybridization between Bi and Fe. Here, the partial DOS of (Ce_{0.5}Bi_{0.5})₂Fe₁₄B was analyzed and show the Fe-4c case here as an example. As shown in the gray region of FIG. 6b, the p-projected DOS in Bi atom show a similar contour to the d-orbital DOS of Fe-4c atom underlying the d-p hybridization. Moreover, in the energy interval of [E_{F}-4.8 eV, E_{F}-3.8 eV], the p-projected DOS peak of Bi comes mainly from the pₓ state (see the inset of FIG. 6b). This feature is consistent with the structural characteristic that Bi-4f and Fe-4c are located in the same xy-plane in the 2:14:1 structure.

TABLE I
The calculated spin (μₛ) and orbital (μ_{L}) magnetic moments on Ce,
Bi, Fe and B atoms in Ce₂Fe₁₄B and (Ce_{0.5}Bi_{0.5})₂Fe₁₄B, respectively.

| | |
|---|---|
| Ce₂Fe₁₄B | (Ce_{0.5}Bi_{0.5})₂Fe₁₄B |

| Atoms | μₛ (μ_{B}) | μ_{L} (μ_{B}) | μₛ (μ_{B}) | μ_{L} (μ_{B}) |
|---|---|---|---|---|
| Ce-4f/Bi-4f | −0.76 | 0.25 | 0.00 | −0.02 |
| Ce-4g | −0.85 | 0.36 | −0.78 | 0.39 |
| Fe-4c | 2.45 | 0.04 | 2.50 | 0.07 |
| Fe-4e | 1.99 | 0.04 | 2.18 | 0.05 |
| Fe-8j1 | 2.30 | 0.03 | 2.30 | 0.04 |
| Fe-8j2 | 2.73 | 0.04 | 2.80 | 0.04 |
| Fe-16k1 | 2.25 | 0.04 | 2.34 | 0.05 |
| Fe-16k2 | 2.35 | 0.04 | 2.41 | 0.05 |
| B-4g | −0.14 | 0.00 | −0.16 | 0.00 |

Given the promising magnetic properties in (Ce₁₋ₓBiₓ)₂Fe₁₄B, further Bi-substituted compounds were fabricated. Notably, significant impediments were encountered for synthesizing Bi-doped Ce₂Fe_{12.7}Co_{1.3}B via conventional arc melting and post annealing process due to phase separation. Here, we estimate the thermodynamic stability of (Ce_{0.5}Bi_{0.5})₂Fe₁₄B by the enthalpies of formation ΔH_{f} and potential decomposition enthalpies ΔH_{d} by the grand canonical linear programming method (A. R. Akbarzadeh et al., Adv. Mater. 19, 3233, 2007).

The ΔH_{f}, on a per-atom basis, is calculated based on the elementary substances as follows:

$${ΔH}_{f} = [ H ( {( {Ce}_{0.5} {Bi}_{0.5} )}_{2} {Fe}_{14} B ) - H ( Ce ) - H ( Bi ) - 14 H ( Fe ) - H ( B ) ] / 17 \qquad ( 1 )$$

where the applied enthalpy denotes the total enthalpy of related materials. The enthalpies of Ce, Bi, Fe and B were calculated in their stable phases in the Materials Project data base (e.g., A. R. Akbarzadeh et al., Ibid.). As listed in Table II below, the calculated ΔH_{f} of 0.028 eV/atom in (Ce_{0.5}Bi_{0.5})₂Fe₁₄B is higher than that in Ce₂Fe₁₄B. Given that a system with a lower formation enthalpy will be more stable at high temperatures, the (Ce_{0.5}Bi_{0.5})₂Fe₁₄B seems unstable with respect to the formation of Ce₂Fe₁₄B. However, the R₂Fe₁₄B structure could be formed with R=Y, Th and all the lanthanide elements except Eu and Pm. The formation enthalpies of these R₂Fe₁₄B materials range from −0.125 eV/atom (in Lu₂Fe₁₄B) and 0.727 eV/atom (in Gd₂Fe₁₄B). Parts of R₂Fe₁₄B are listed in Table II. Thus, it is entirely possible that the (Ce_{0.5}Bi_{0.5})₂Fe₁₄B with ΔH_{f} of 0.028 eV/atom may form under appropriate synthesis conditions.

TABLE II
The enthalpies of formation (ΔH_{f}), decompositions and related
decomposition enthalpies (ΔH_{d}) of (Ce_{0.5}Bi_{0.5})₂Fe₁₄B,
R₂Fe₁₄B (R═Ce, Pr, Nd, Sm or Gd) and stable binary compounds
with Ce, Bi, Fe or B atoms in Materials Project data base. Ce(FeB)₄
is also listed, as one of the decomposed material of Ce₂Fe₁₄B.

| | ΔH_{f} | | ΔH_{d} |
|---|---|---|---|
| Compounds | (eV/atom) | Decompose to | (eV/atom) |
| (Ce_{0.5}Bi_{0.5})₂Fe₁₄B | 0.028 | discussed | discussed |
| Ce₂Fe₁₄B | −0.071 | Ce(FeB)₄ + CeFe₂ + Fe | 0.019 |
| Pr₂Fe₁₄B | 0.218 | Pr(FeB)₄ + Pr + Fe | 0.273 |
| Nd₂Fe₁₄B | 0.190 | Nd(FeB)₄ + Nd + Fe | 0.247 |
| Sm₂Fe₁₄B | −0.078 | Stable | . . . |
| Gd₂Fe₁₄B | 0.727 | Gd₂Fe₁₇ + GdFe₄B + Fe | 0.800 |
| CeBi | −0.813 | Stable | . . . |
| CeBi₃ | −0.439 | Stable | . . . |
| Ce₂Bi | −0.547 | Stable | . . . |
| Ce₄Bi₃ | −0.702 | Stable | . . . |

Moreover, except the magnetic anisotropy and saturation magnetization, Curie point is an indispensable property for permanent magnet application. Co substitution may be employed in (Ce_{0.75}Bi_{0.25})₂Fe₁₄B and (Ce_{0.5}Bi_{0.5})₂Fe₁₄B to achieve a higher Curie point. The magnetization and anisotropy for the two Bi cases with the Co content of 10% and 15% were calculated by employing the virtual crystal approximation to treat the Fe/Co substitution. It was herein found that the magnetizations of the two Bi cases were nearly unaffected by the introduced Co. The magnetic anisotropy of 2.48 MJ/m³ in (Ce_{0.75}Bi_{0.25})₂Fe₁₄B decreases to 1.80 MJ/m³ (with 10% Co) and 2.18 MJ/m³ (with 15% Co). In (Ce_{0.5}Bi_{0.5})₂Fe₁₄B, the magnetic anisotropy of 4.24 MJ/m³ decreased to 3.77 MJ/m³ (with 10% Co) and 3.82 MJ/m³ (with 15% Co). It can be roughly assessed that the magnetic anisotropies of the two Bi cases decrease 10%-12% by proper Co substitution. Thus, although the Co substitution decreases the magnetic anisotropy in the two Bi cases, it remains possible to control the magnetic anisotropy by optimizing the content of Co. These results lay the foundation for low-cost Ce₂Fe₁₄B-based permanent magnet applications.

Notably, even for magnetic anisotropy fields in the ˜3 Tesla room-temperature values found experimentally, it should still be feasible to make high-performance magnets in this class. Relying on the time-tested Brown paradox in which experimentally realizable coercivities can be as high as 30% of the anisotropy field results in estimated coercivities as high as 0.9 T or 9 kOe, which exceeds half the approximate 1.4 Tesla room-temperature magnetization of these alloys. This would thus permit these magnets to be made in any shape free of demagnetization effects, and obtain the full energy product as high as 48 MG-Oe. Although not studied here, previous work (J. F. Herbst, Rev. Mod. Phys., 63, 819, 1991) also finds that in Ce₂Fe₁₄B and La₂Fe₁₄B, anisotropy fields are nearly constant in the technologically important range just above room temperature, rather than falling off quickly with temperature as in Nd₂Fe₁₄B. It is this latter property that has largely necessitated the unfavorable usage of the extremely critical Dy in conventional magnet compositions. In contrast, the presently described Ce₂Fe₁₄B-based magnets do not require Dy, which substantially reduces room-temperature energy products.

### Further Experiments

Commercial grade (>99.9 wt % purity) Mischmetal (“MM”), Fe, Co, Fe—B, Cu, and Ga were used to prepare the master alloy with a nominal composition of (MM)_{2.6}Fe_{11.9}Co₂Ga_{0.1}B. The approximate composition of the Mischmetal is given in Table 3 below:

TABLE 3
Composition of Mischmetal in wt %
MM composition in wt %

| | |
|---|---|
| La | 30 |
| Ce | 60 |
| Nd + Pr | 10 |

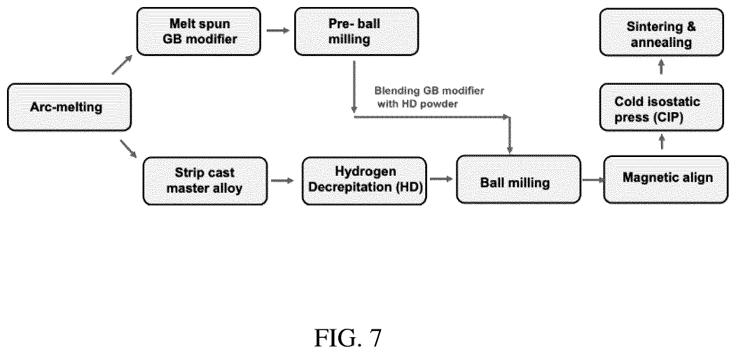

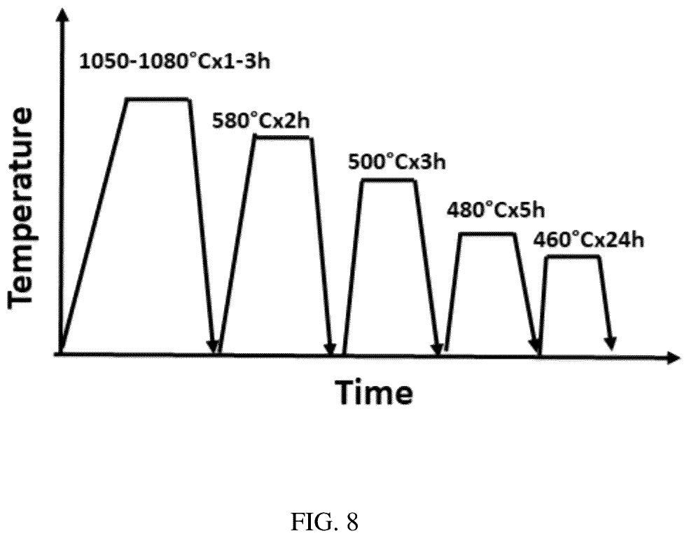

The alloys were first arc-melted, then strip-cast to flakes (˜125 mm thickness) with the wheel speed set at 1.5 m/s. The flakes were further treated with hydrogen decrepitation process and ground into coarse powders (200-400 μm). The powder of the grain boundary modifier alloy Pr₆₈Cu₃₂ (mole ratio) or Pr₃₄Dy₃₄Cu₃₂ were prepared by arc-melting, melt-spinning, and pre-ball-milling processes. The obtained coarse Pr—Cu or Pr—Dy—Cu powder (˜75 μm) was added to the master MM-FeCoGa-B coarse powder at a ratio of 7.5 wt. %. The mixture was ball-milled to finer powder (˜3.5 μm), then aligned with a 9 T pulsed field in a rubber die, and cold isostatic pressed with a hydrostatic pressure of 500 MPa. These processes are shown in FIG. 7. The obtained green compacts were sintered and annealed in a vacuum furnace by following the sintering and annealing schedule shown in FIG. 8.

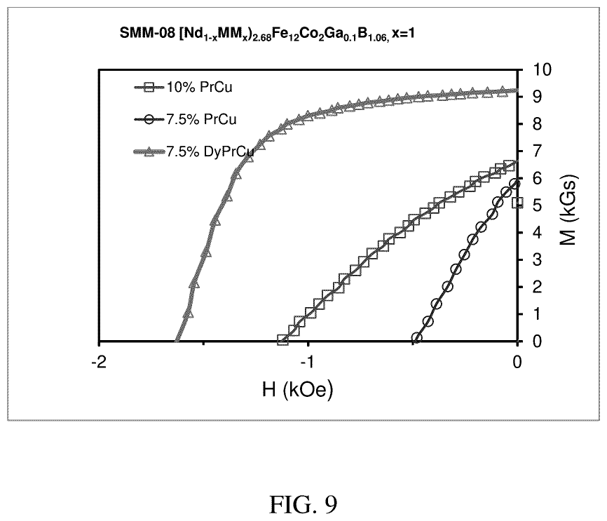

Room-temperature hysteresis loops for alloys, employing the indicated grain boundary modifiers, are depicted in FIG. 9, along with the measured properties in Table 4 below. Notably, despite an approximate 90% reduction in effective neodymium content relative to current NdFeB magnets, useful permanent magnet performance with energy products approaching 8 MG-Oe are observed. This energy product is nearly double that of current commercial strontium hexaferrite magnets, further demonstrating the technological potential of this magnet class.

TABLE 4
Achieved saturation magnetization (Mₛ), remanence
(Mᵣ), coercivity (H_{cj}) and energy product BHₘₐₓ for
the alloys with hysteresis loops depicted in FIG. 9

| | Pr₆₈Cu₃₂, | Pr₆₈Cu₃₂, | Dy₃₄Pr₃₄Cu₃₂, |
|---|---|---|---|
| | 7.5% | 10% | 7.5% |
| Mₛ | 10.3 | 9.8 | 9.8 |
| (kGs) | | | |
| Mᵣ | 5.7 | 6.3 | 9.2 |
| (kGs) | | | |
| H_{cj} | 0.5 | 1.1 | 1.6 |
| (kGs) | | | |
| (BH)ₘₐₓ | 0.8 | 2.0 | 7.6 |
| (MGOe) | | | |

### CONCLUSION

In summary, the magnetic properties of Ce₂Fe₁₄B with Co, La and Zr substitutions were examined. Together with the Co substitutions on Fe, partial Zr substitution increases the impurity phase and has little effect on the Curie point and Mₛ. Without the loss of anisotropy field, substitution of La improves the Curie temperature and Mₛ, which may produce an estimated energy product as high as 48 MG-Ge. These properties indicate LaCeFe_{12.7}Co_{1.3}B as a particularly high performance permanent magnet which is advantageously critical-element-free. Moreover, the results indicate that the magnetic anisotropy of Ce₂Fe₁₄B is comparably contributed by the Ce and Fe atoms. Then the Ce-projected magnetic anisotropy is predominately provided by the Ce atoms in 4g site. In particular, employing the Bi substitution on the Ce atoms in the 4g site can increase the magnetic anisotropy energy to 4.24 MJ/m³ in (Ce_{0.5}Bi_{0.5})₂Fe₁₄B, which is almost three times of that in Ce₂Fe₁₄B. Meanwhile, (Ce_{0.5}Bi_{0.5})₂Fe₁₄B exhibits a strong magnetization of 1.64 T and a magnetic hardness parameter of 1.41. These magnetic criteria also imply the potential of Bi substitution for making Ce₂Fe₁₄B a low-cost, high-performance permanent magnet. These experimental and theoretical results provide a foundation for developing Ce₂Fe₁₄B-based critical-element-free, high performance, low-cost permanent magnets.

While there have been shown and described what are at present considered the preferred embodiments of the invention, those skilled in the art may make various changes and modifications which remain within the scope of the invention defined by the appended claims.

What is claimed is:

1. A bulk permanent magnet composition comprising the formula (Ce₁₋ₓM¹ₓ)_{2.7-(v+w)}M²ᵥ(Fe_{14-y}Co_{y})_{1-z}M³_{z}B, wherein:
M¹ represents at least one lanthanide element other than Ce;
M² represents at least one element selected from the group consisting of Sn, Sb, Bi, Pb, Ca, Sr, and Zr;
M³ represents at least one element selected from the group consisting of Ti, Cr, Mn, Ni, Cu, Zn, Zr, Nb, Mo, W, Ta, and Hf;
0≤x<1; 0≤v≤1; 0≤y≤3; 0≤w≤0.8; and 0≤z≤1.

2. The composition of claim 1, wherein 0<x<1.

3. The composition of claim 1, wherein 0.1≤x<1.

4. The composition of claim 1, wherein 0.1≤x≤0.8.

5. The composition of claim 1, wherein 0<y≤3.

6. The composition of claim 1, wherein 0≤y≤2.

7. The composition of claim 1, wherein 0<y≤2.

8. The composition of claim 1, wherein M¹ represents at least La from among the one or more lanthanide elements.

9. The composition of claim 1, wherein M¹ represents La.

10. The composition of claim 1, wherein M¹ excludes Nd.

11. The composition of claim 1, wherein M² represents at least Bi and/or Zr from among the group consisting of Sn, Sb, Bi Pb, Ca, Sr, and Zr.

12. The composition of claim 1, wherein 0.01≤v≤1.

13. The composition of claim 1, wherein 0<v≤1.

14. The composition of claim 1, wherein 0<v≤0.4.

15. The composition of claim 1, wherein 0<v≤0.2.

16. The composition of claim 1, wherein 0.1≤v≤1.

17. The composition of claim 1, wherein 0<z≤1.

18. The composition of claim 1, wherein 0.01≤z≤1.

19. The composition of claim 1, wherein 0.1≤z≤1.

20. The composition of claim 1, wherein 0<v≤1 and 0<z≤1.

21. The composition of claim 1, wherein the composition comprises the sub-formula (Ce₁₋ₓM¹ₓ)₂₋ᵥM²ᵥ(Fe_{14-y}Co_{y})_{1-z}M³_{z}B.

22. The composition of claim 21, wherein 0.01≤v≤1.

23. The composition of claim 21, wherein 0.01≤z≤1.

24. The composition of claim 21, wherein z is 0 and the composition thus comprises the formula (Ce₁₋ₓM¹ₓ)₂₋ᵥM²ᵥ(Fe_{14-y}Co_{y})B.

25. The composition of claim 24, wherein 0.01≤v≤1.
